(19) United States
(12) Patent Application Publication
(10) Pub. No.: US 2025/0036712 A1
(43) Pub. Date: Jan. 30, 2025

(54) OPTIMIZATION DEVICE, OPTIMIZATION METHOD AND OPTIMIZATION PROGRAM

(71) Applicant: NEC Corporation, Minato-ku, Tokyo (JP)

(72) Inventor: Akihiro YATABE, Tokyo (JP)

(73) Assignee: NEC Corporation, Minato-ku, Tokyo (JP)

(21) Appl. No.: 18/713,751

(22) PCT Filed: Nov. 7, 2022
(86) PCT No.: PCT/JP2022/041342

§ 371 Date: May 28, 2024

(30) Foreign Application Priority Data
Nov. 30, 2021 (JP) 2021-194081

(51) Int. Cl. G06F 17/11

(52) U.S. Cl. CPC G06F 17/11

(57) ABSTRACT

The optimization device 90 includes a determining means 91 and an optimizing means 92. The determining means 91 determines a type of combinatorial optimization problem from a QUBO matrix obtained by QUBO modeling of a combinatorial optimization problem that includes a two-way one-hot condition as a constraint condition. The optimizing means 92 performs optimization process according to the determined type of combinatorial optimization problem.

### TECHNICAL FIELD

This invention relates to an optimization device, an optimization method, and an optimization program for optimization according to a combinatorial optimization problem.

### BACKGROUND ART

The combinatorial optimization problem is the problem of trying to find the best combination based on a certain index among the choices regarding the combination, and deriving a combination of values of variables that optimize a given index under various constraints. Combinatorial optimization problems are applicable to various everyday situations, but due to the nature of the problem, they are also known to explode in computational complexity as the scale of the problem increases.

In order to solve such problems, various methods have recently been proposed to solve optimization problems using simulated annealing (sometimes referred to as SA) or quantum annealing. For example, Patent Literature 1 describes a production planning method for creating a production plan that maximizes productivity. In the method described in Patent Literature 1, the objective function and constraints for the product production planning problem are formulated as a QUBO (Quadratic Unconstrained Binary Optimization) model or an Ising model, and an annealing machine is used to obtain the optimal solution.

Non Patent Literature 1 describes a solution to the constrained slot placement problem using an Ising machine.

### CITATION LIST

### Patent Literature

PL 1: Japanese Unexamined Patent Publication No. 2020-140615

### Non Patent Literature

NPL 1: Sho KANAMARU, Kazushi KAWAMURA, Shu TANAKA, Yoshinori TOMITA, Nozomu TOGAWA, “Solving Constrained Slot Placement Problems Using an Ising Machine and Its Evaluations”, IEICE Transactions on Information and Systems, Volume E104.D, Issue 2, Pages 226-236, 2021

### SUMMARY OF INVENTION

### Technical Problem

The Ising model is a simple model for calculating the spin orientation of atoms constituting a crystal and is one of the formulations of the combinatorial optimization problem. The QUBO model is another formulation of the combinatorial optimization problem, and the matrix representing the coefficients of the QUBO model is called the QUBO matrix. Since the QUBO model and Ising model can be converted one-to-one, the QUBO-modeled combinatorial optimization problem can be solved by an annealing machine.

And it is possible in principle to solve the QUBO-modeled combinatorial optimization problem directly with an annealing machine. However, when a QUBO model of the combinatorial optimization problem is simply used as it is, there exist cases where a near-optimal solution is difficult to obtain, and it may also take a lot of time.

In the method described in Patent Literature 1, a combinatorial optimization problem formulated by a spatio-temporal network model for production planning in a production line is converted into a QUBO model or an Ising model to derive the optimal solution. However, even when solving the QUBO model converted from the combinatorial optimization problem formulated in this way, the above possibilities still exist, and it is unclear how to optimize the problem more appropriately. Therefore, it is preferable to be able to perform a more appropriate optimization process according to the QUBO-modeled optimization problem.

Therefore, it is an object of the present invention to provide an optimization device, an optimization method, and an optimization program that can perform an appropriate optimization process according to the QUBO-modeled optimization problem.

### Solution to Problem

The optimization device according to the present invention includes: a determining means which determines a type of combinatorial optimization problem from a QUBO matrix obtained by QUBO modeling of a combinatorial optimization problem that includes a two-way one-hot condition as a constraint condition; and an optimizing means which performs optimization process according to the determined type of combinatorial optimization problem.

The optimization method according to the present invention includes: determining a type of combinatorial optimization problem from a QUBO matrix obtained by QUBO modeling of a combinatorial optimization problem that includes a two-way one-hot condition as a constraint condition, by a computer; and performing optimization process according to the determined type of combinatorial optimization problem, by the computer.

The optimization program according to the present invention for causing a computer to execute: determining process for determining a type of combinatorial optimization problem from a QUBO matrix obtained by QUBO modeling of a combinatorial optimization problem that includes a two-way one-hot condition as a constraint condition; and optimizing process for performing optimization process according to the determined type of combinatorial optimization problem.

### Advantageous Effects of Invention

According to the present invention, an appropriate optimization process can be performed according to the QUBO-modeled optimization problem.

### BRIEF DESCRIPTION OF DRAWINGS

FIG. 1 It depicts an explanatory diagram showing a configuration example of a first example embodiment of the optimization device according to the present invention.

FIG. 2 It depicts an explanatory diagram showing an example of a two-way one-hot condition.

FIG. 3 It depicts an explanatory diagram showing an example of an order optimization problem.

FIG. 4 It depicts an explanatory diagram showing an example of a QUBO matrix including one-hot conditions.

FIG. 5 It depicts an explanatory diagram showing another example of a QUBO matrix including one-hot conditions.

FIG. 6 It depicts an explanatory diagram showing an example of distribution of a non-zero component of an order optimization problem.

FIG. 7 It depicts an explanatory diagram showing an example of distribution of a non-zero component of TSP.

FIG. 8 It depicts an explanatory diagram showing an example of distribution of a non-zero component of QAP.

FIG. 9 It depicts an explanatory diagram showing an example of a QUBO matrix.

FIG. 10 It depicts an explanatory diagram showing an example of a block extracted from the QUBO matrix of TSP.

FIG. 11 It depicts an explanatory diagram showing another example of a block extracted from the QUBO matrix of TSP.

FIG. 12 It depicts an explanatory diagram showing an example of clustering by sorting.

FIG. 13 It depicts an explanatory diagram showing an example of clustering by sorting.

FIG. 14 It depicts an explanatory diagram showing an example of a divided subproblem.

FIG. 15 It depicts an explanatory diagram showing an example of TSP between regions.

FIG. 16 It depicts an explanatory diagram showing an example of a result of inserting a solution for each region.

FIG. 17 It depicts an explanatory diagram showing an example of a process of inserting an optimal solution.

FIG. 18 It depicts an explanatory diagram showing an example of contents output by an output unit.

FIG. 19 It depicts an explanatory diagram showing an example of a QUBO matrix showing an objective function part of TSP and QAP.

FIG. 20 It depicts an explanatory diagram showing an example of a division tried in each direction for a variable.

FIG. 21 It depicts an explanatory diagram showing an example of a case in which the result “only one can be divided” is derived.

FIG. 22 It depicts an explanatory diagram showing an example of the optimization process performed for each index.

FIG. 23 It depicts an explanatory diagram showing an example of a case in which the result “case in which both can be divided” is derived.

FIG. 24 It depicts an explanatory diagram showing another example of contents output by an output unit.

FIG. 25 It depicts an explanatory diagram showing an overview of an algorithm for solving the order optimization problem.

FIG. 26 It depicts an explanatory diagram showing an example of a QUBO matrix showing a setup time optimization problem.

FIG. 27 It depicts an explanatory diagram showing an example of a matrix showing setup time.

FIG. 28 It depicts an explanatory diagram showing an example of a process of extracting necessary components from a QUBO matrix.

FIG. 29 It depicts an explanatory diagram showing an example of how to formulate a problem.

FIG. 30 It depicts an explanatory diagram showing another example of how to formulate a problem.

FIG. 31 It depicts an explanatory diagram showing another example of contents output by an output unit.

FIG. 32 It depicts a flowchart showing an example of operation of the optimization device of the first example embodiment.

FIG. 33 It depicts a flowchart showing another example of operation of the optimization device of the first example embodiment.

FIG. 34 It depicts a flowchart showing another example of operation when the problem is identified as an order optimization problem.

FIG. 35 It depicts a flowchart showing another example of operation when the problem is identified as TSP.

FIG. 36 It depicts a flowchart showing another example of operation when the problem is identified as QAP.

FIG. 37 It depicts an explanatory diagram showing a configuration example of a second example embodiment of the optimization device according to the present invention.

FIG. 38 It depicts a flowchart showing an example of operation of the optimization device of the second example embodiment.

FIG. 39 It depicts an explanatory diagram showing a configuration example of a third example embodiment of the optimization device according to the present invention.

FIG. 40 It depicts a flowchart showing an example of operation of the optimization device of the third example embodiment.

FIG. 41 It depicts a block diagram showing an overview of the optimization device according to the present invention.

### DESCRIPTION OF EMBODIMENTS

### Example Embodiment 1

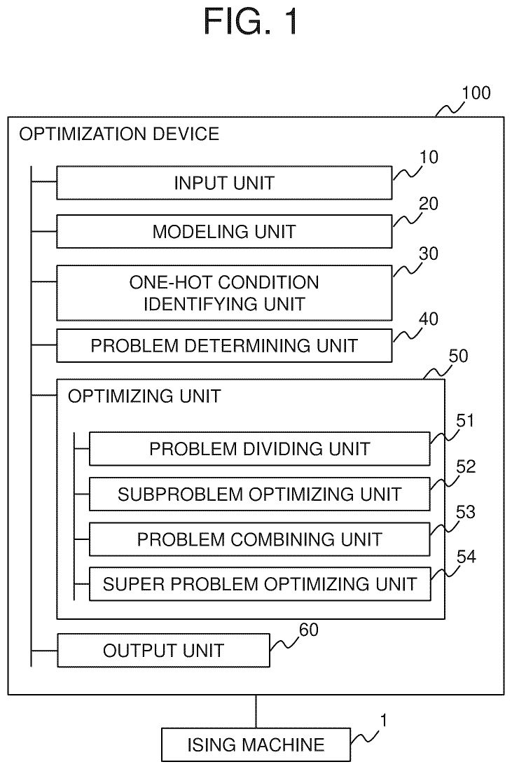

The following is a description of an embodiment of the invention with reference to the drawings. FIG. 1 is an explanatory diagram showing a configuration example of a first example embodiment of the optimization device according to the present invention. The optimization device of the example embodiment shown below is a device that performs the appropriate optimization process according to a QUBO modeled optimization problem.

First of all, it is explained the combinatorial optimization problem handled in the following example embodiment. In the following example embodiment, a situation is assumed in which a problem of determining the order of things as in Traveling Salesman Problem (TSP) or a problem of associating two types of things in a one-to-one correspondence as in Quadratic Assignment Problem (QAP) is to be optimized.

In these problems, it is known that one-hot conditions are imposed on the variables to be optimized. Specifically, if a variable is defined as a binary (0 or 1) two dimensional array x_{i,j} to solve TSP or QAP, a one-hot condition is imposed on this variable with respect to the horizontal (i) and vertical (j) directions. In the following description, such a condition is referred to as a two-way one-hot condition. That is, in a QUBO matrix, the two-way one-hot condition is the part of the QUBO matrix represented by a square matrix whose non-zero components do not overlap in the vertical and horizontal directions.

The two-way one-hot condition can be formulated as in Equations 1 and 2 below for the horizontal (i) and vertical (j) directions, respectively.

$$\begin{matrix}[ Math . 1 ] & \\ {\sum }_{j} {( {\sum }_{i} {x}_{ij} - 1 )}^{2} & ( Equation 1 )\end{matrix}$$

$${\sum }_{i} {( {\sum }_{j} {x}_{ij} - 1 )}^{2} \qquad ( Equation 2 )$$

For example, in the case of TSP, when the order to be visited is i and the location to be visited is j, then xᵢⱼ is a variable (array) that represents whether location j is the i-th location to be visited (1) or not (0). This can be said to be a variable indicating that a location is to be visited only once, and only one location is to be visited at a time. It is assumed that d_{j,k} is the distance between location j and location k, then the objective function to be optimized (minimized) can be expressed as in Equation 3 below, since the TSP only needs to consider the union of locations that are adjacent in order. In the case of TSP, the distance from the last location to the first location to be visited is also included in the objective function, so when i is equal to the number of cities in Equation 3, i+1 is read as 1. For example, when five locations are to be visited, i+1 in Equation 3 should be read as 1.

$$\begin{matrix}[ Math . 2 ] & \\ {\sum }_{i , j , k} {d}_{jk} {x}_{i , j} {x}_{i + 1 , k} & ( Equation 3 )\end{matrix}$$

Another example is the problem of placing one factory in each region as QAP. This would be the problem of minimizing the total cost of transporting goods between factories (a value expressed as the product of distance and flow of goods) when one factory is located in each of several regions. Let factory i be a factory and region j be a region, then xᵢⱼ is a variable (array) that represents whether factory i is located in region j (1) or not (0). This can be said to be a variable indicating that there is only one factory existing in a region and only one region in which a factory exists.

When f_{i,k} is the flow between factory i and factory k, and d_{j,l} is the distance between region j and region l, then the objective function to be optimized (minimized) is expressed as in Equation 4 below. Unlike the TSP, the QAP includes in its objective function not only the coupling between regions that are neighbors in order, but also all couplings with other regions.

$$\begin{matrix}[ Math . 3 ] & \\ {\sum }_{i , j , k , l} {f}_{ik} {d}_{jl} {x}_{ij} {x}_{kl} & ( Equation 4 )\end{matrix}$$

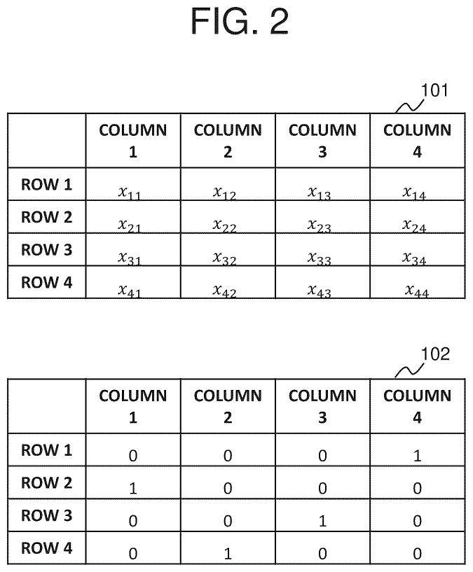

FIG. 2 is an explanatory diagram showing an example of a two-way one-hot condition. In the example shown in FIG. 2, array 101 shows an example of variables in a array, and array 102 shows an example of variables values that satisfies a two-way one-hot condition. For example, if the array 102 shown in FIG. 2 exhibits variables used in the TSP, it indicates that location 4 is visited first, location 1 is visited second, location 3 is visited third, and location 2 is visited fourth.

The following example embodiments deal with problems in which two-way one-hot conditions are imposed, such as TSP and QAP. However, the combinatorial optimization problems handled in the following example embodiments are not limited to TSP and QAP. Any optimization p in which a two-way one-hot condition is imposed as described above are not limited to widely known optimization problems such as TSP and QAP.

For example, a problem of minimizing the cost of setup for each product to be produced when multiple products are all produced once is also an optimization problem that imposes a two-way one-hot condition. This is because the costs required for setup (e.g., changes in equipment, personnel, etc.) differ depending on the order of products to be produced. In the following description, the problem of optimizing the order in this way is referred to as an order optimization problem. This problem can also be referred to as TSP that does not cycle.

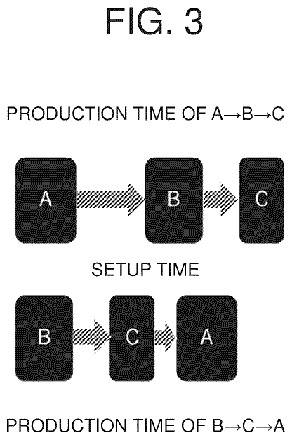

FIG. 3 is an explanatory diagram showing an example of an order optimization problem. The example shown in FIG. 3 indicates that when producing the three types of products A, B, and C, the production time is calculated assuming not only the production time for each product, but also the time required to prepare each product for production (setup time). As shown in FIG. 3, since the overall production time varies depending on the order in which the products are produced, the order optimization problem can be said to be a problem of optimizing the order so that this production time is minimized. For example, in the example shown in FIG. 3, if a large amount of setup time is required from Product A to Product B, it is better to avoid that order.

In this order optimization problem, when the order of production is i and the product is j, then xᵢⱼ is a variable (array) that represents whether the i-th product j is produced (1) or not (0). This can be said to be a variable indicating that a product is produced only once and only one product is produced at a time.

When c_{j,k} is the cost of the setup required to change from product j to product k, the objective function to be optimized (minimized) is expressed as shown in Equation 5 below.

$$\begin{matrix}[ Math . 4 ] & \\ {\sum }_{i , j , k} {c}_{jk} {x}_{i , j} {x}_{i + 1 , k} & ( Equation 5 )\end{matrix}$$

Another example of a combinatorial optimization problem is the problem of determining the path with the shortest travel distance when the starting city and the goal city are fixed and all cities along the way are visited once. This is not the same as the commonly known TSP, but it is a combinatorial optimization problem in which a two-way one-hot condition is imposed.

As described above, the following example embodiment describes how to perform the optimization process appropriately for different types of combinatorial optimization problems involving two-way one-hot conditions.

As shown in FIG. 1, an optimization device 100 of the first example embodiment includes an input unit 10, a modeling unit 20, a one-hot condition identifying unit 30, a problem determining unit 40, an optimizing unit 50, and an output unit 60.

The optimization device 100 is connected to an Ising machine 1, which performs the optimization process. The Ising machine 1 is a device that searches for optimal solutions of an Ising model and the QUBO model. The Ising machine 1 is realized, for example, by an annealing machine.

The input unit 10 accepts input of a combinatorial optimization problem. The input unit 10 may, for example, accept input of a formulated optimization problem (e.g., objective function and constraints). The input unit 10 may also accept input of a QUBO-modeled optimization problem (e.g., a QUBO matrix). If the input unit 10 accepts input of a QUBO-modeled optimization problem, the optimization device 100 may not be equipped with the modeling unit 20.

The modeling unit 20 obtains the QUBO matrix by QUBO modeling the combinatorial optimization problem. The modeling unit 20 may QUBO model the combinatorial optimization problem using any known method. For example, TSP, QAP, and the order optimization problem are all well-known problems that can be represented by QUBO models, and the method of obtaining a QUBO matrix by QUBO modeling is widely known, so a detailed explanation is omitted here.

The one-hot condition identifying unit 30 identifies two-way one-hot conditions in the QUBO matrix. Specifically, the one-hot condition identifying unit 30 identifies a square matrix of variables from the QUBO matrix within which non-zero components do not overlap in the vertical and horizontal directions. For example, the one-hot condition identifying unit 30 identifies a two-way one-hot condition from the QUBO matrix, as shown in FIG. 2. The QUBO matrix is a matrix representation of the coefficient part of the QUBO modeled combinatorial optimization problem and corresponds to the underlined matrix in the Hamiltonian shown in Equation 6 below.

$$\begin{matrix}[ Math . 5 ] & \\ H = {\sum }_{i = 1}^{N - 1} {\sum }_{j = i + 1}^{N} {J}_{ij} {x}_{i} {x}_{j} + {\sum }_{i = 1}^{N} {h}_{i} {x}_{i} = ( \begin{matrix}{x}_{1} & {x}_{2} & … & {x}_{N} )\end{matrix} & ( Equation 6 )\end{matrix}$$

$$( \begin{matrix}{Q}_{11} & {Q}_{12} & … & {Q}_{1 N} \\ 0 & {Q}_{22} & … & {Q}_{2 N} \\ ⋮ & ⋮ & ⋱ & ⋮ \\ 0 & 0 & … & {Q}_{NN}\end{matrix} )$$

$$( \begin{matrix}{x}_{1} \\ {x}_{2} \\ ⋮ \\ {x}_{N}\end{matrix} )$$

In Equation 6, the diagonal component of the QUBO matrix (e.g., Q₁₁) corresponds to hi and the off-diagonal component (e.g., Q₁₂) corresponds to Jᵢⱼ.

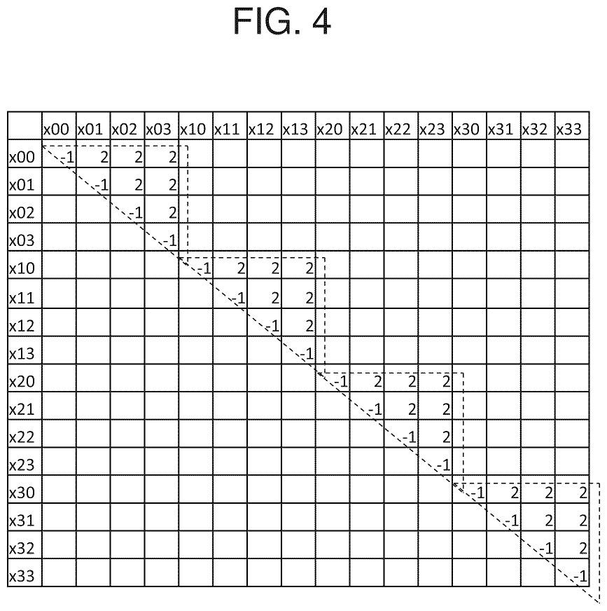

FIG. 4 is an explanatory diagram showing an example of a QUBO matrix including one-hot conditions. The QUBO matrix shown in FIG. 4 is a QUBO matrix that shows the one-hot conditions in the horizontal direction (more specifically, i in the variable xᵢⱼ), indicating that the variables are a 4×4 combination. As shown in FIG. 4, this QUBO matrix shows that the components are arranged in a triangular range along the diagonal.

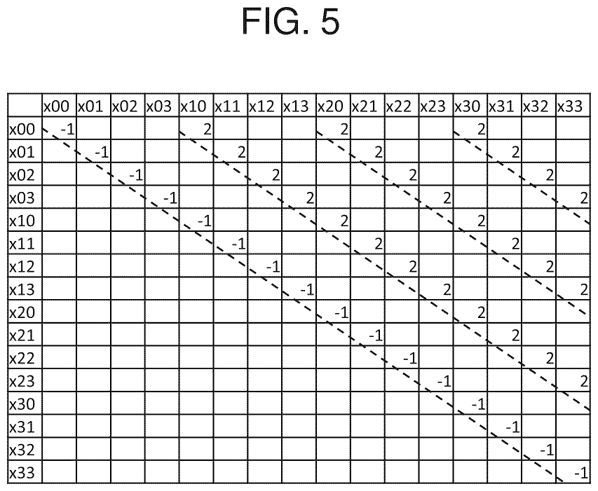

FIG. 5 is an explanatory diagram showing another example of a QUBO matrix including one-hot conditions. The QUBO matrix shown in FIG. 5 is a QUBO matrix showing the one-hot conditions in the vertical direction (more specifically, j in the variable xᵢⱼ), indicating that the variable is a 4×4 combination. As shown in FIG. 5, this QUBO matrix shows that the components of j are aligned in the direction parallel to the diagonal.

Then, the one-hot condition identifying unit 30 removes the components indicating the identified two-way one-hot condition from the original QUBO matrix. The term “remove” here means to set the component to zero. In the following explanation, the matrix from which the two-way one-hot condition is removed from the QUBO matrix is referred to as the objective function part of the QUBO matrix.

The method by which the one-hot condition identifying unit 30 identifies the two-way one-hot conditions in the QUBO matrix and the objective function part is arbitrary. For example, the one-hot condition identifying unit 30 may identify the objective function part from the QUBO matrix using the coefficient parameters of the two-way one-hot condition predicted from the values of the diagonal components of the QUBO matrix, or the coefficient parameters indicated in advance.

It is assumed here that the objective function part is generated by removing the two-way one-hot condition from the QUBO matrix. However, if the part excluding the two-way one-hot condition can be identified in a way, the one-hot condition identifying unit 30 does not have to explicitly remove the component. The one-hot condition identifying unit 30 may, for example, generate a matrix that shows a mask that identifies the components to be removed (or left).

The problem determining unit 40 determines a type of combinatorial optimization problem from the matrix from which the two-way one-hot condition is removed from the QUBO matrix (i.e., the objective function part). Specifically, the problem determining unit 40 determines the type of the combinatorial optimization problem based on the distribution of the non-zero components of the objective function part.

Below, it is explained in detail why it is possible to determine the type of combinatorial optimization problem based on the distribution of the non-zero components of the objective function part. For example, problems involving two-way one-hot conditions include TSP and QAP, described above. It is known that TSP and QAP have different problem difficulty levels, with QAP being more difficult. The inventor of the present invention found that the difference between the problems appears in the QUBO matrix when TSP and QAP are QUBO-modeled, excluding the two-way one-hot condition (i.e., the objective function part). For example, TSP has more zero components in the matrix excluding the two-way one-hot condition (i.e., the objective function part) than QAP.

In addition, the form of the components of the QUBO matrix based on the two-way one-hot condition is fixed, and the TSP and QAP are explicit that the two-way one-hot condition contains constraints. Therefore, the type of combinatorial optimization problem can be determined by observing the distribution of the non-zero components of the objective function part.

Furthermore, the inventor found that a characteristic distribution of non-zero components appears in the objective function part, depending on the problem. Here, the distribution of non-zero components includes not only the distribution of every single non-zero component, but also the distribution of a square matrix containing non-zero components (hereinafter sometimes referred to as a block).

Therefore, the distribution of non-zero components may be predetermined according to the type of combinatorial optimization problem, and the problem determining unit 40 may compare the objective function part with the predetermined distribution to determine the type of optimization problem corresponding to the matching or similar distribution.

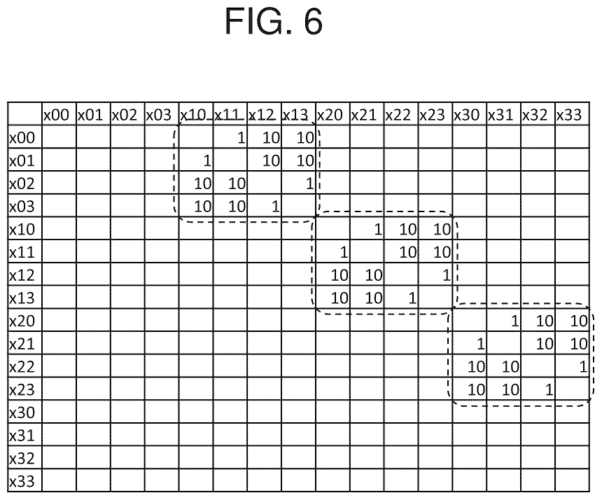

The distribution of the non-zero components in the TSP, QAP, and order optimization problems described above is explained below. First of all, the distribution of the order optimization problem is explained. FIG. 6 is an explanatory diagram showing an example of distribution of a non-zero component of an order optimization problem. The example shown in FIG. 6 is for the case where there are 4 items (products) when the QUBO matrix is an upper triangular matrix. As shown in FIG. 6, in the case of the order optimization problem, the non-zero components (blocks) appear at the point where the first index of the variable (i.e., i in the variable xᵢⱼ) is shifted by one. In the case of the order optimization problem, this block can be said to be a matrix of costs, since the objective function is the sum of the costs (e.g., setup time, described above) associated with moving to the next item (product).

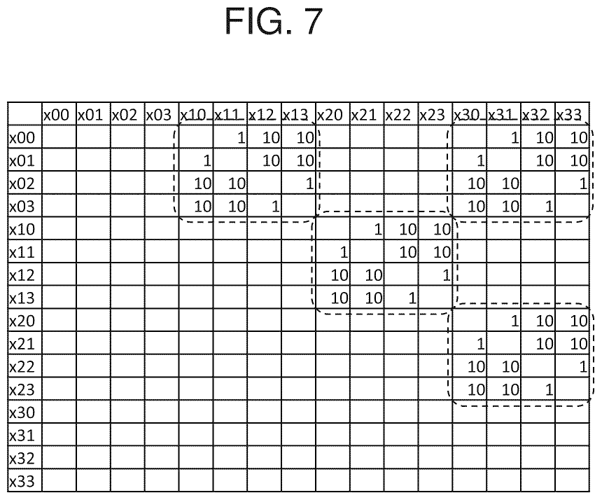

Next, the distribution for the case of TSP is explained. FIG. 7 is an explanatory diagram showing an example of distribution of a non-zero component of TSP. The example shown in FIG. 7 is for the case where there are 4 cities when the QUBO matrix is an upper triangular matrix. As shown in FIG. 7, the non-zero components (blocks) of the TSP appear at the point where the first index of the variable (i.e., i in variable xᵢⱼ) is shifted by one and at the upper right corner. In the case of the TSP, the objective function is the total distance traveled, so this block can be said to be a matrix of distances.

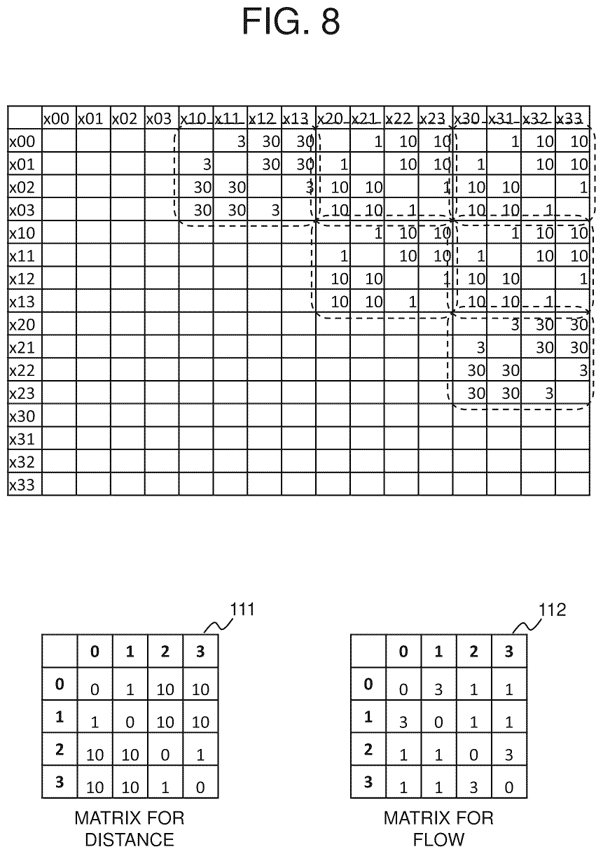

Next, the distribution for the case of QAP is explained. FIG. 8 is an explanatory diagram showing an example of distribution of a non-zero component of QAP. The example shown in FIG. 8 is for the case where there are 4 plants when the QUBO matrix is an upper triangular matrix. As shown in FIG. 8, the non-zero components (blocks) of the QAP appear exhaustively in the upper triangular part of the matrix. In the case of QAP, the objective function is the sum of distance x flow, this block can be said to contain two different matrices (matrix 111 for distance and matrix 112 for flow).

Note that in these three types of problems, the components within a block differ from each other by only a constant multiple. However, even if the components within each block are different, they can be solved in the same way if the components are greater than zero.

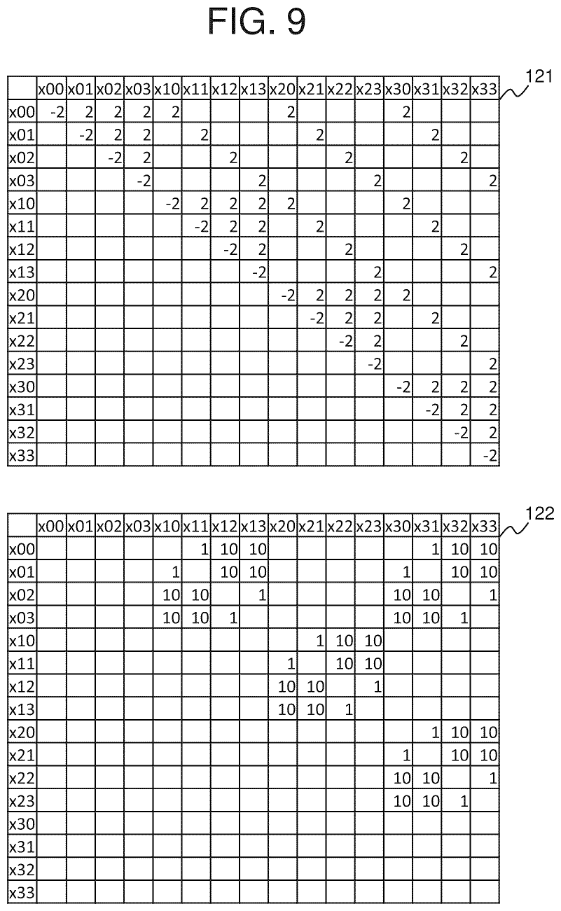

The relationship between the constraints and the objective function in the QUBO matrix is explained here. FIG. 9 is an explanatory diagram showing an example of a QUBO matrix. Matrix 121 in FIG. 9 is an example of a matrix showing constraints (two-way one-hot conditions), and matrix 122 is an example of a matrix showing an objective function (e.g., a collection of matrices of distances).

The constraints are conditions that must be satisfied, and the objective function aims at optimization (minimization) after satisfying the constraints. Therefore, in the Hamiltonian, the absolute values of the components of the QUBO matrix are larger than those of the constraint conditions. To achieve this, each term of the Hamiltonian is multiplied by a coefficient. In the example shown in FIG. 9, the coefficients are set so that the absolute value of the component of matrix 121 is greater than the absolute value of the component of matrix 122.

The optimizing unit 50 performs optimization process according to the determined type of the combinatorial optimization problem. For example, when solving a combinatorial optimization problem by simulated annealing, problem division may be performed according to the context of the problem to be solved in order to obtain a solution closer to the optimal solution in a shorter time. Therefore, the optimizing unit 50 in this example embodiment performs problem division according to the type of combinatorial optimization problem so that a more appropriate optimization process can be performed.

As shown in FIG. 1, the optimizing unit 50 includes a problem dividing unit 51, a subproblem optimizing unit 52, a problem combining unit 53, and a super problem optimizing unit 54.

The problem dividing unit 51 performs problem division for the QUBO matrix according to the determined type of the combinatorial optimization problem. The problem division for a QUBO matrix is the process of extracting blocks from the QUBO matrix (more specifically, the objective function part) that are square matrices including non-zero components (i.e., parts of the objective function). The blocks to be extracted are arbitrary. For example, in the case of the QUBO matrix shown in FIG. 7, the problem dividing unit 51 may extract the upper left block (4×4 square matrix).

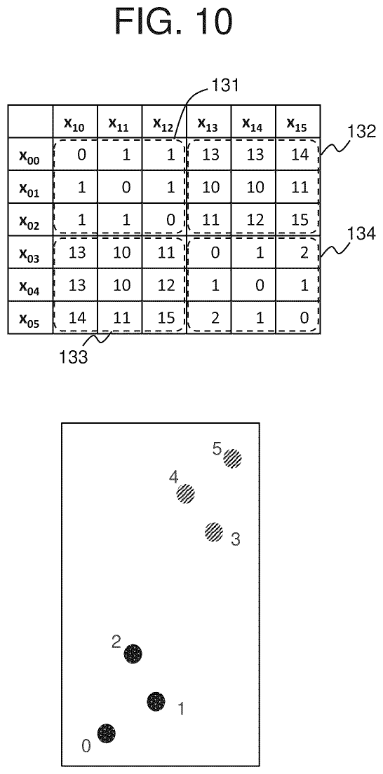

The specific process of the optimizing unit 50 is explained below, using the problem division of the TSP as an example. FIG. 10 is an explanatory diagram showing an example of a block extracted from the QUBO matrix of TSP. FIG. 10 shows the case where there are two groups of three cities in close proximity. In the example shown in FIG. 10, city 0, city 1 and city 2 are in close proximity, and city 3, city 4 and city 5 are in close proximity. In the case of TSP, the blocks that are part of the objective function can be said to be a matrix of distances. Therefore, each component of the block shown in FIG. 10 represents the distance between cities.

The example shown in FIG. 10 indicates that city 0, city 1, and city 2 are in close proximity, which means that the distance (component) between these cities is small (distance=1), and that city 3, city 4, and city 5 are also in close proximity, which means that the distance (component) between each city is small (distance=1 or 2). Similarly, the example shown in FIG. 10 indicates that the distances (components) between cities that are not in close proximity are large (distances greater than 10).

Since the goal of TSP is to minimize distance, it is assumed that subblock 131 and subblock 134 will be used instead of subblock 132 and subblock 133 as shown in FIG. 10.

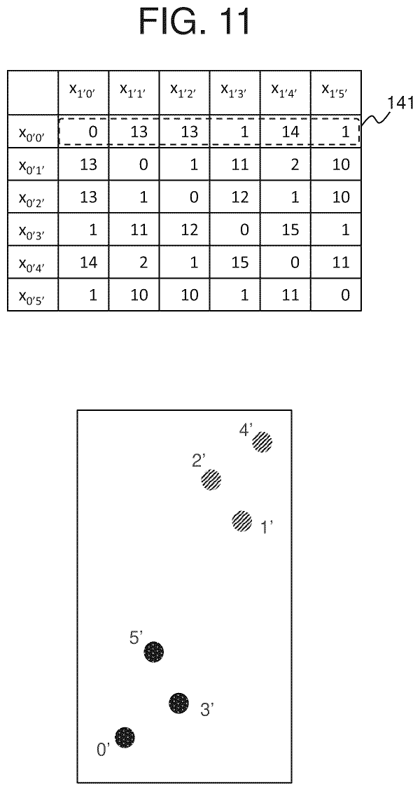

The example shown in FIG. 10 shows the case where cities that are close in distance are defined as close indices to each other. However, a case in which cities that are far apart are defined as close indices is also conceivable. FIG. 11 is an explanatory diagram showing another example of a block extracted from the QUBO matrix of TSP.

The example shown in FIG. 11 is a case in which cities with close distances are not defined as close indices to each other. In this case, the problem dividing unit 51 may sort the indices of the city so that the components are in ascending order. For example, focusing on row 141 shown in FIG. 11, the block shown in FIG. 10 can be obtained by sorting the indices 0′ to 5′ as 0, 3, 4, 1, 5, and 2, respectively. Since this sorting can group processes in close proximity, this sorting process can be called clustering by sorting (sometimes simply referred to as “clustering” below).

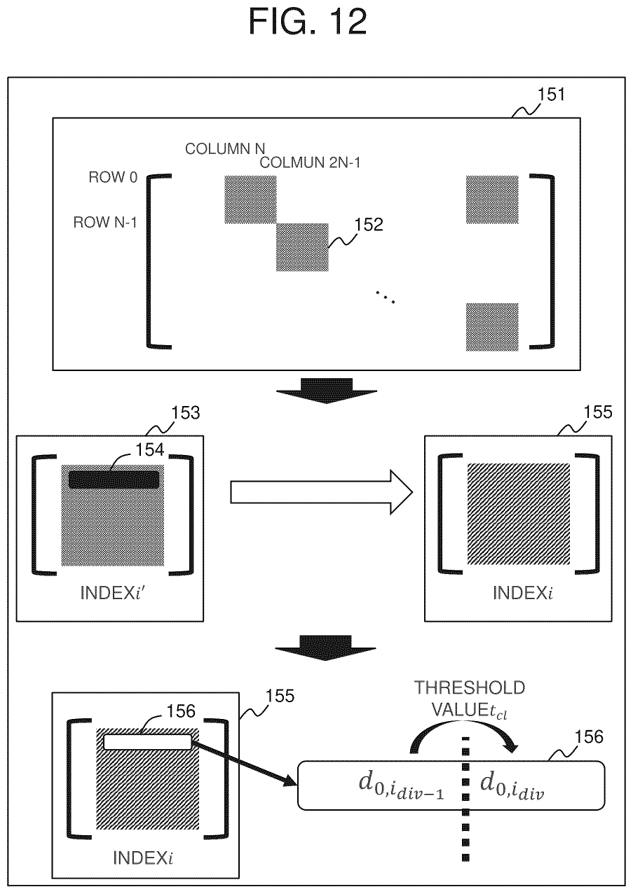

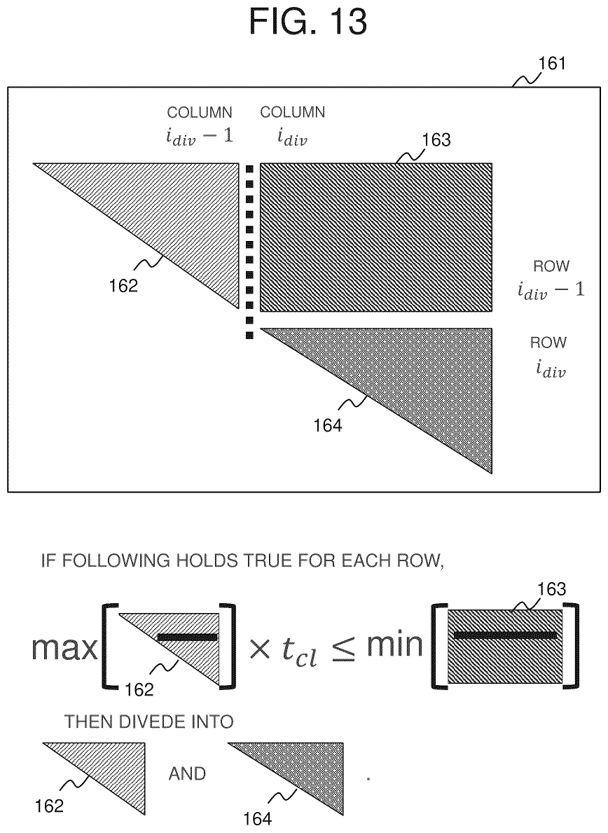

The following is a more general explanation of sorting (clustering) of components within a block. FIG. 12 and FIG. 13 are explanatory diagrams showing an example of clustering by sorting. First, the problem dividing unit 51 extracts from the QUBO matrix (specifically, the objective function part) 151 FIG. 13e blocks 152, which are square matrices including non-zero components. In the case of TSPs, the blocks 152 are matrices of distances, and for the TSP in N cities, all matrices of distances appearing in the objective function part are equal. Therefore, the problem dividing unit 51 may extract, for example, the square matrices from row 0 to row N−1 and from column N to column 2N−1, as shown in FIG. 12.

Next, the problem dividing unit 51 generates a block 155 with the indices sorted so that the values of the components in the first row (line 0) 154 of the extracted block 153 are in ascending order. Then, a threshold value t_{cl} of components to be divided into sub-blocks is defined in advance, and the problem dividing unit 51 maintains a column index i_{div} that may divide the components among themselves if the difference between adjacent components exceeds the predefined threshold value. The definition content of this threshold value t_{cl} is arbitrary. The threshold t_{cl} may, for example, be defined as the ratio between adjacent components or the difference between adjacent components.

In the example shown in FIG. 12, in the first row 156 of the sorted block, the ratio between the component d_{0,idiv-1} and the component d_{0,idiv} is t_{cl} times or more, which indicates that it is determined that there is a possibility of division.

Next, as shown in FIG. 13, for each row in the components of the upper triangular part 161 in the block, excluding the diagonal components, the problem dividing unit 51 determines if it can divide the left component matrix 162 up to the column index i_{div-1} column that may be divide and the right component matrix 163 from the column index i_{div} column to the right. Specifically, for each row, the problem dividing unit 51 extracts the left component matrix 162 up to column index i_{div-1} if the ratio or difference between the left component matrix 162 and the right component matrix 163 is greater than the threshold t_{cl}.

For example, if t_{cl} is defined as a threshold of a factor, then for each row, the problem dividing unit 51 determines whether all of the components in the right component matrix 163 are greater than or equal to the threshold ti times the components in the left component matrix 162. If the threshold value t_{cl} times or more, then the problem dividing unit 51 extracts the left component matrix 162 up to column index i_{div-1}. Hereafter, the problem indicated by the extracted component matrices is sometimes referred to as the subproblem. In FIG. 13, max[•] and min[•] mean the maximum and minimum values of the components, respectively.

The problem dividing unit 51 then extracts the lower right side from the remaining i_{div} rows i_{div} columns. The above process is repeated for the extracted part 161 of the upper triangle.

Thus, if the problem dividing unit 51 generates a block with the indices sorted so that the values of the components in the first row of the extracted block are in ascending order, and if the ratio or difference of adjacent components exceeds a predetermined threshold t_{cl}, generates a new block by dividing the square matrix including the rows up to the adjacent left component. This makes it possible to divide the square matrix (block) from which the elements to be considered are extracted.

Next, other methods of problem division are described. The method described next is a division method using agglomerative clustering. Agglomerative clustering assumes that all points are initially included in different clusters, and repeats the process of joining clusters Cᵢ and Cⱼ with the smallest distance d (Cᵢ, Cⱼ) between clusters to finally join them into a single cluster.

Various methods are known to define the distance between clusters, including the shortest distance method (single-connected method), the longest distance method (fully connected method), and the group average method as methods that do not require the center of gravity. Here, a method similar to the generally known group average method will be described to perform problem division using the interaction terms (non-diagonal component) Qᵢⱼ (however, i≠j) of the QUBO matrix of the problem to be divided. Note that the off-diagonal component is assumed to be greater than or equal to 0, as is the distance, so the absolute value of the component is used in the division process.

In the general group average method, the distance between different clusters is calculated as the value obtained by averaging the distance between points by the number of cluster elements, as shown in Equation 7 below. Note that | Cᵢ | and | Cⱼ | shown in Equation 7 indicate the number of elements in clusters i and j.

$$\begin{matrix}[ Math . 6 ] & \\ d ( {C}_{i} , {C}_{j} ) = \frac{1}{\vert {C}_{i} \vert \vert {C}_{j} \vert} {\sum }_{{x}_{k} ∈ {C}_{i}} {\sum }_{{x}_{l} ∈ {C}_{j}} d ( {x}_{k} , {x}_{l} ) & ( Equation 7 )\end{matrix}$$

On the other hand, in a method similar to the group average method used in this example embodiment, the average of the absolute values of the interaction terms between variables between different clusters is the absolute value of the interaction terms between clusters after combining. Specifically, let the clusters be a set of indices of variables, and define the matrix of distances between clusters Dᵢⱼ as in Equation 8 below. Note that Cᵢ={i₀, i₁, . . . , iₙᵢ₋₁} and Cⱼ={j₀, j₁, . . . , jₙⱼ₋₁}. The subscript (m) in the distance Dᵢⱼ represents the number of updates. Note that D⁽⁰⁾ᵢⱼ=| Qᵢⱼ |.

$$\begin{matrix}[ Math . 7 ] & \\ {D}_{ij}^{( m + 1 )} = \frac{1}{\vert {C}_{i} \vert \vert {C}_{j} \vert} {\sum }_{k ∈ {C}_{i}} {\sum }_{l ∈ {C}_{j}} {D}_{kl}^{( m )} & ( Equation 8 )\end{matrix}$$

In the general group average method, the distance between the newly combined cluster (Cᵢ+Cⱼ) and cluster Cₖ is calculated by Equation 9 shown below.

$$\begin{matrix}[ Math . 8 ] & \\ d ( {C}_{k} , {C}_{i} + {C}_{j} ) = \frac{\vert {C}_{i} \vert}{\vert {C}_{i} + {C}_{j} \vert} d ( {C}_{k} , {C}_{i} ) + \frac{\vert {C}_{j} \vert}{\vert {C}_{i} + {C}_{j} \vert} d ( {C}_{k} , {C}_{j} ) & ( Equation 9 )\end{matrix}$$

On the other hand, in a method similar to the group average method used in this example embodiment, the absolute value of the interaction term between the newly combined cluster (Cᵢ+Cⱼ) and cluster Cₖ is calculated by Equation 10 shown below.

$$\begin{matrix}[ Math . 9 ] & \\ {D}_{k , i + j}^{( m + 1 )} = \frac{\vert {C}_{i} \vert}{\vert {C}_{i} + {C}_{j} \vert} {D}_{k , i}^{( m )} + \frac{\vert {C}_{j} \vert}{\vert {C}_{i} + {C}_{j} \vert} {D}_{k , j}^{( m )} & ( Equation 10 )\end{matrix}$$

The problem dividing unit 51 creates clusters by combining each variable, and when the clusters are combined, the process of updating the matrix of distances is repeated until predefined conditions (number of clusters, etc.) are met.

Thus, in the division method using agglomerative clustering, as shown in Equation 8 above, the average of the sum of the components in the QUBO matrix of the clusters, which is the set of indices of the variables, is defined as the distance between the clusters, and the problem dividing unit 51 combines clusters that are close in distance to each other and extracts blocks by repeating the process of combining clusters until predefined conditions are met. This allows the indices of the QUBO matrix to be aggregated until a predetermined condition (e.g., the number of divisions) is met, thus enabling the QUBO matrix to be divided into desired blocks.

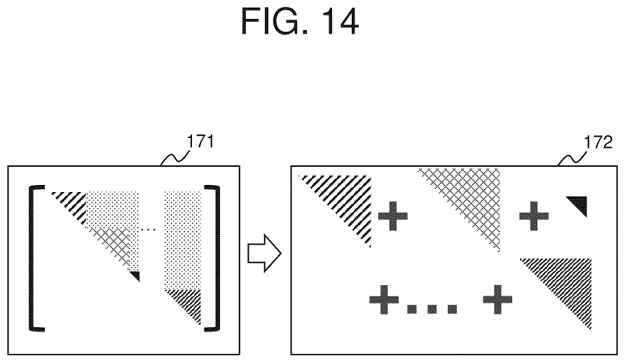

The subproblem optimizing unit 52 formulates the problem (i.e., each subproblem) indicated by each component matrix of the extracted blocks and performs the optimization process. The formulation and optimization methods are determined according to the original combinatorial optimization problem. For example, if the divided problem is TSP, the subproblems can be said to be TSPs for the divided region. FIG. 14 is an explanatory diagram showing an example of a divided subproblem. The example shown in FIG. 14 indicates that the objective function part 171 which represents a matrix of distances is divided, and divided into a matrix of distances 172 for each region.

The subproblem optimizing unit 52 optimizes each of the problems indicated by the divided matrices. In the case of TSP, the subproblem optimizing unit 52 optimizes each of the TSPs indicated by the divided matrices (i.e., the TSPs divided by each region). The subproblem optimizing unit 52 may, for example, cause the Ising machine 1 to search for the optimal solution of the subproblem. The method of causing the Ising machine 1 to search for the optimal solution of TSP is widely known, and a detailed explanation is omitted here.

Note that the variables included in the matrix of distances 172 are fewer than those included in the objective function part 171, making it possible to obtain the optimal solution for each subproblem in a shorter time.

The problem combining unit 53 combines obtained optimization results of the obtained subproblem and formulates a new combinatorial optimization problem. In the following description, the new combinatorial optimization problem that combines the optimization results of the subproblems is sometimes referred to as a super problem.

The super problem is a combinatorial optimization problem generated by optimizing and combining subproblems obtained by dividing a combinatorial optimization problem to be solved first. Therefore, the result of optimizing the super problem can be regarded as the result of optimizing the original combinatorial optimization problem.

The formulation method may be determined according to the original combinatorial optimization problem. The following is a specific explanation for the case where the original combinatorial optimization problem is TSP.

The problem combining unit 53 selects two cities that are contiguous in order out of the order within the region optimized in the subproblem. These two cities are cities that connect to other regions and correspond to the start and goal cities in the region. The method of selecting these two cities is arbitrary, and the problem combining unit 53 may, for example, select them randomly. If there is only one city, the problem combining unit 53 may select only that city. In this case, that city serves as both the start city and the goal city.

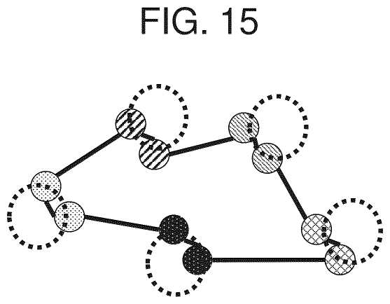

The problem combining unit 53 then formulates the TSP visiting the two cities selected for each region as a new combinatorial optimization problem. FIG. 15 is an explanatory diagram showing an example of TSP between regions. The example shown in FIG. 15 indicates that two cities are selected per region and the problem is formulated as a problem of visiting those cities in order.

The super problem optimizing unit 54 performs the optimization process for the new combinatorial optimization problem (i.e., super problem) that is formulated. The super problem optimizing unit 54 may optimize the super problem formulated by the problem combining unit 53 in a known manner. Specifically, the super problem optimizing unit 54 may cause the Ising machine 1 to search for the optimal solution of the super problem.

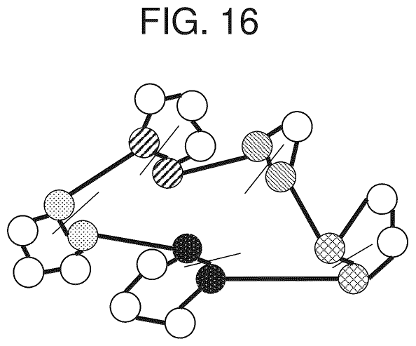

In the case of TSP, after the optimization process for the super problem, the super problem optimizing unit 54 derives the final optimal solution (i.e., the result of optimizing the original combinatorial optimization problem) by inserting the solution of the TSP within a region between the two cities of each region. FIG. 16 is an explanatory diagram showing an example of a result of inserting a solution for each region. The example shown in FIG. 16 shows an example of inserting the optimal solution for each region into the optimal solution for the super problem shown in FIG. 16.

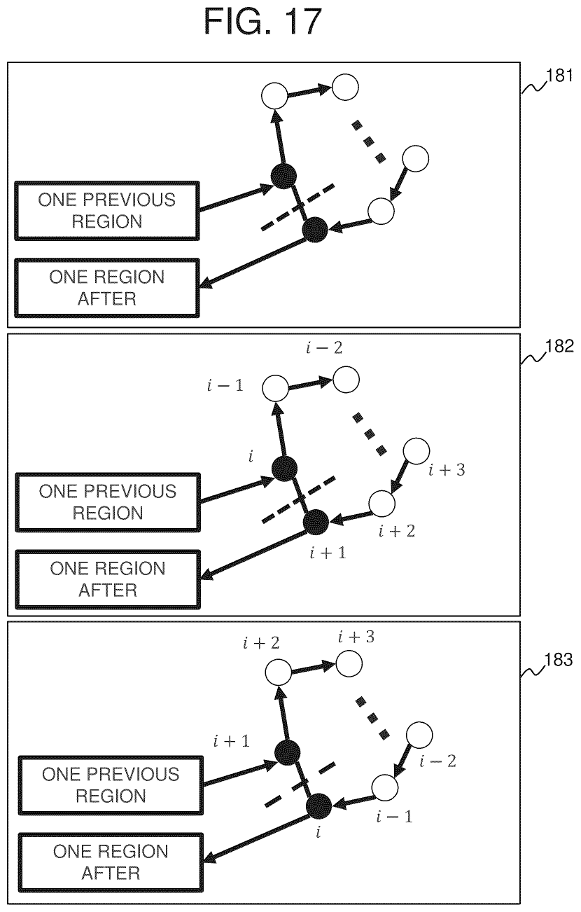

The process of inserting the optimal solution is explained in more detail. FIG. 17 is an explanatory diagram showing an example of a process of inserting an optimal solution. It is assumed that the solution order of the TSP is obtained as (0, 1, . . . , i, i+1, . . . , N−1) as the optimal solution 181 for a certain region. It is also assumed that the i-th and i+1-th cities are selected for the two cities. Here, the optimal solution for the overall TSP is the one that travels from one previous region to the city in this region and then to the region one after. Therefore, the route of the tour within a region is determined by whether the city connected to the previous region is the i-th city or the i+1-th city.

First, it is assumed that the city connected from one previous region is the i-th city, and the city connected to one subsequent region is the i+1-th city. In this case, as shown in the optimal solution 182, the route that visits the local TSP solutions in reverse order is the optimal solution for the overall TSP. On the other hand, it is assumed that the city connected from one previous region is the i+1-th city, and the city connected to one subsequent region is the i-th city. In this case, as shown in the optimal solution 183, the route that visits the local TSP solutions in the same order is the optimal solution for the overall TSP.

The output unit 60 outputs the optimization results. The content output by output unit 60 is arbitrary, as long as the optimization results can be confirmed. The output unit 60 may display the optimization results on the screen or output them to a file such as csv (Comma Separated Value). If there are many sorting elements, outputting to a file makes it easier to perform operations such as sorting.

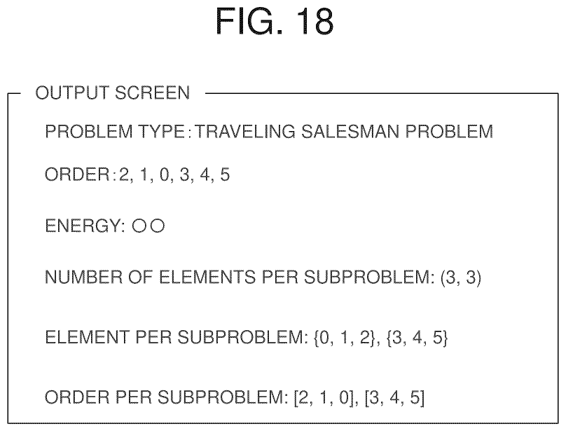

FIG. 18 is an explanatory diagram showing an example of contents output by an output unit 60. The output content shown in FIG. 18 shows the output content of TSP. Here, it is assumed that there are six types of elements (i.e., cities to visit) to be rearranged: 0, 1, 2, 3, 4, and 5.

Although the example shown in FIG. 18 shows element numbers, it is possible to output specific cities and product names by mapping element numbers to element names. The same is true for the following examples of output.

The example shown in FIG. 18 indicates that the output unit 60 outputs the final order results along with the problem type, TSP (traveling salesman problem). Since the solution to TSP is interpreted as “2→1→0→3→4→5→2” by connecting the first and the last in order, the result shown in FIG. 18 is an example of an optimization result. For example, instead of “2” for the starting point, it could be “1”.

The example shown in FIG. 18 also indicates that the output unit 60 outputs the final order together with the energy calculated from the QUBO matrix of the original optimization problem. This energy can be used as an indicator that a smaller number is considered a better solution.

In addition, FIG. 18 shows an example where the output unit 60 outputs the number of elements per subproblem, the elements per subproblem, and the order per subproblem. The example shown in FIG. 18 indicates that the original problem can be divided into two subproblems with three variables each, and that the variables within each subproblem are {0, 1, 2} and {3, 4, 5}. It further indicates that the order of each subproblem is [2, 1, 0] and [3, 4, 5]. The display style shown in FIG. 18 (e.g., parentheses) is an example, and various methods may be used. The same applies to the following examples of output.

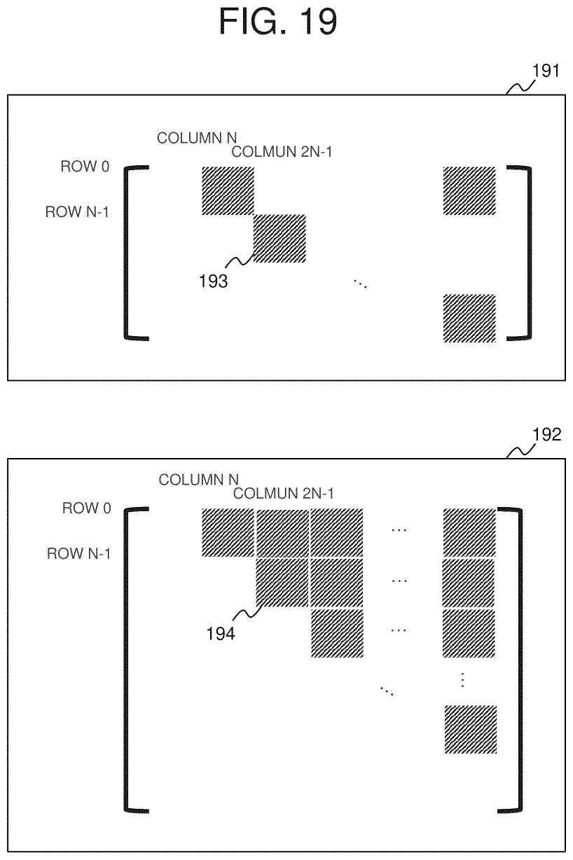

The above description shows the operation of the optimizing unit 50 and output unit 60 using TSP as an example. However, the combinatorial optimization problem targeted by the optimization device 100 of this example embodiment is not limited to TSP. Next, other specific processes of the optimizing unit 50 are described, comparing the problem division of QAP with that of TSP described above. FIG. 19 is an explanatory diagram showing an example of a QUBO matrix showing an objective function part of TSP and QAP.

Matrix 191 shown in FIG. 19 shows the matrix of the objective function of the TSP (the objective function part), and matrix 192 shows the matrix of the objective function of the QAP (the objective function part). As in FIG. 7, the non-zero components (blocks) 193 of the TSP appear at the first index of the variable (i.e., i in the variable xᵢⱼ) shifted by 1 and at the upper right. In the QAP, in the objective function part of the QUBO matrix, the non-zero components (blocks) 194 of the QAP appear exhaustively in the upper triangular part of the matrix. In the following description, each block 194 is sometimes written as a “distance” matrix. Unlike the blocks in the TSP, the blocks 194 in the QAP are not equal to each other.

Among the “distance” matrices, there are at most (N−1)(N−1)/2 matrices whose components are non-zero. Therefore, the problem dividing unit 51 identifies the blocks to be used as criteria for clustering and performs clustering of variables using the identified blocks.

The method by which the problem dividing unit 51 identifies the matrix is arbitrary. The problem dividing unit 51 may, for example, identify the block with the largest component among the blocks as the criteria block. Otherwise, the problem dividing unit 51 may, for example, identify the block with the largest sum of components in the block as the criteria block. In that case, the problem dividing unit 51 may maintain the order of the blocks calculated at the time of identification in descending order of the calculated values.

Next, the problem dividing unit 51 tries to see if clustering is possible for each of the horizontal (i) and vertical (j) directions. Specifically, the problem dividing unit 51 swaps the indices of the variables (i.e., xᵢⱼ→xⱼᵢ) and tries to see if clustering is possible in either direction. This leads to one of the following results: not divisible with respect to either variable, divisible with respect to one variable, or divisible with respect to both variables.

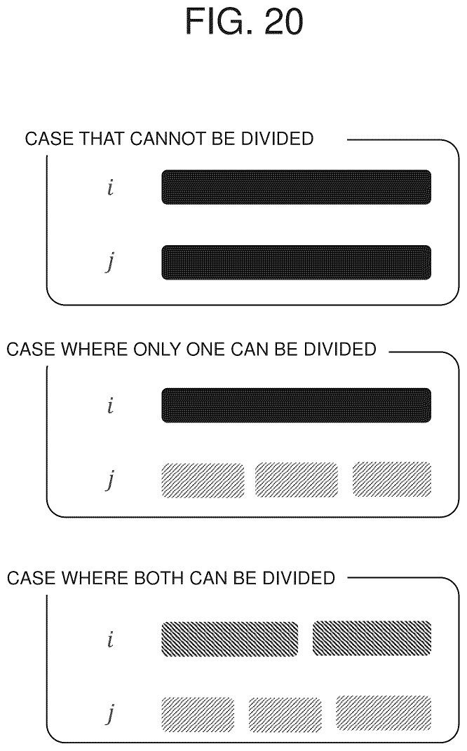

FIG. 20 is an explanatory diagram showing an example of a division tried in the i and j directions for a variable xᵢⱼ. For example, if the QAP is the problem of placing one factory in each region, in FIG. 20, the “case where both can be divided” means that dividing is possible for factory i and region j, respectively. The “case where only one can be divided” means that the factory can be divided for either factory i or region j.

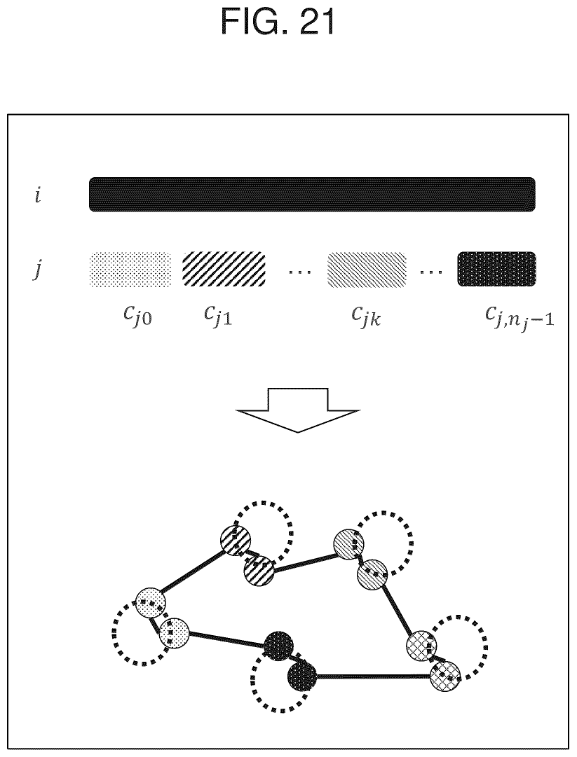

First, the case in which the result “only one can be divided” is derived is explained. FIG. 21 is an explanatory diagram showing an example of a case in which the result “only one can be divided” is derived. If the QAP is the problem of placing one factory in each region, the situation shown in FIG. 21 can be said to be the problem of deciding where to place a factory, for example, when land is clustered in different regions.

Here, it can be seen that the problem shown in FIG. 21 is similar to the TSP problem shown in FIG. 15. Therefore, the subproblem optimizing unit 52 optimizes the QAP subproblem as TSP problem. Specifically, the subproblem optimizing unit 52 uses the divided “distance” matrix to determine the order j of the variable indices for each k-th cluster cⱼₖ of index j.

Next, the problem combining unit 53 selects two elements that are adjacent in order and formulates a new combinatorial optimization problem, similar to the method shown in FIG. 15. Then, the super problem optimizing unit 54 performs the optimization process for the new formulated combinatorial optimization problem (i.e., super problem). Specifically, the super problem optimizing unit 54 derives the final optimal solution (i.e., the result of optimizing the original combinatorial optimization problem) by inserting the solution of the TSP in the cluster between the two elements of each cluster, as shown in FIG. 16.

In this example embodiment, the super problem optimizing unit 54 optimizes the QAP problem as TSP problem. This is expected to have the effect of reducing the cost by solving the TSP, since the “distance” matrix is a cost.

Also, the solution of the optimization performed for one index is simply the order with respect to index j. In general, however, the cost varies depending on which index j is assigned to which i. Therefore, the optimizing unit 50 may perform the optimization process for all patterns while changing i by 1, and the solution with the lowest cost may be the optimal solution. Therefore, at most, the optimizing unit 50 may solve the TSP for twice the number of cities as the number of clusters.

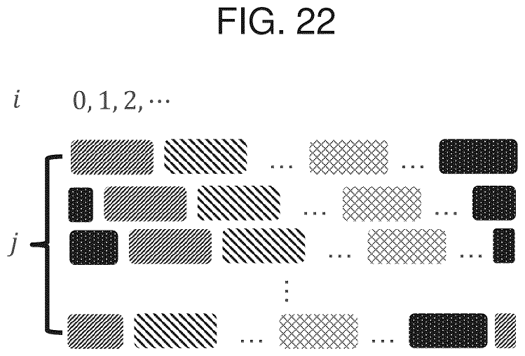

FIG. 22 is an explanatory diagram showing an example of the optimization process performed for each index. The example shown in FIG. 22 indicates that the optimization process regarding the assignment of index j to i is performed while changing the value of i to 0, 1, 2, . . . .

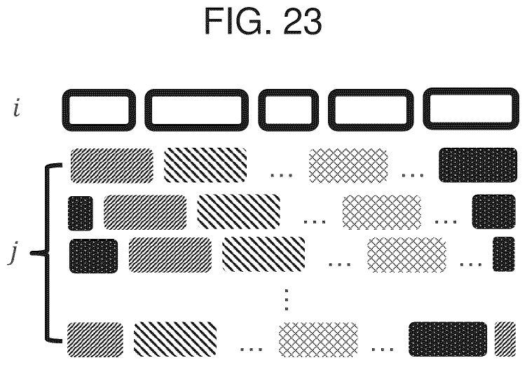

Next, the case in which the result “case in which both can be divided” is derived is explained. FIG. 23 is an explanatory diagram showing an example of a case in which the result “case in which both can be divided” is derived. The example shown in FIG. 23, for example, shows a case where land is clustered by region, and factories with a large exchange of goods are in close proximity.

The “case in which both can be divided” can also be solved by TSP in the same way as the “only one can be divided” method. In the “only one can be divided” case, as shown in FIG. 22, the optimization process is performed for all patterns while changing i by 1. On the other hand, in the “case in which both can be divided” case, the optimization process may be performed for each cluster of i, as shown in FIG. 23.

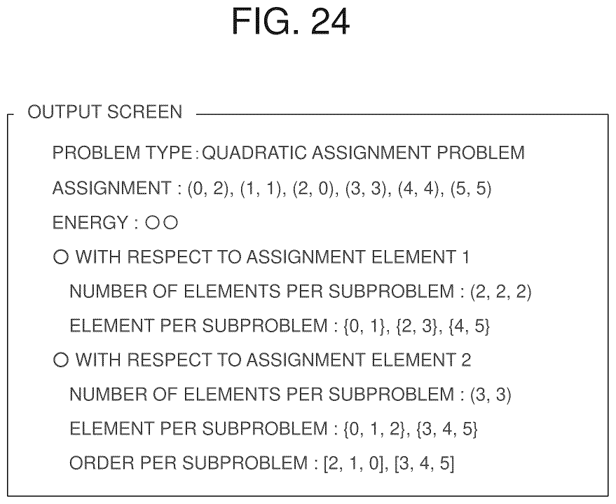

FIG. 24 is an explanatory diagram showing another example of contents output by an output unit 60. The output content shown in FIG. 24 shows the output content of the QAP. The example shown in FIG. 24 assumes a combinatorial optimization problem in which six different elements (0-5) are assigned, and (the element to which the solution is assigned, the element that assigns the solution) is noted. Let i in the variable xᵢⱼ of the QAP be assigned element 1 and j be assigned element 2.

The example shown in FIG. 24 assumes that both element 1 and element 2 could be clustered, and indicates that the output unit 60 outputs the final assignment result, along with the problem type, QAP (quadratic assignment problem). For example, (0, 2) indicates that the 0th “element to be assigned” is assigned the 2nd “element to assigned”.

The example shown in FIG. 24 also shows that the final assignment result is output together with the energy calculated from the QUBO matrix of the original optimization problem, similar to what is shown in FIG. 18. This energy can also be used as an indicator that a smaller number is considered a better solution.

Furthermore, FIG. 24 shows an example of outputting the number of elements per subproblem, elements per subproblem, and order per subproblem for each assigned element. Note that only clustering is performed for the “element to be assigned” (element 1). As for the “elements to assign” (element 2), the order is also derived in order to optimize it like TSP.

If only one of the elements could be clustered, for example, “Number of elements per subproblem (6)” and “Elements per subproblem {0, 1, 2, 3, 4, 5}” would be displayed with respect to assignment element 1.

The above description shows the operation of the optimizing unit 50 and the output unit 60 using QAP as an example. The optimization device 100 can also be used for solving other order optimization problems as described above. Next, further specific process of the optimization unit 50 when solving a sequential optimization problem will be explained while comparing with the above-mentioned TSP and QAP.

Hereinafter, a method for solving the order optimization problem is explained using a specific example of the problem of optimizing the production plan (order of production) (hereinafter referred to as “production plan setup time optimization problem” or “setup time optimization problem”) so as to minimize the setup time shown in FIG. 3. The setup time refers to the time that cannot be used for production due to equipment preparation (e.g., setting changes, cleaning, etc.) when switching products to be produced.

The order optimization problem may include constraints on the order of products. For example, the constraint “product 1 must not be manufactured after product k” can be defined by Equation 11 shown below. Here, P is the coefficient for the penalty and is set to a large positive number.

$$\begin{matrix}[ Math . 10 ] & \\ {\sum }_{i = 0}^{N - 2} {\sum }_{j = i + 1}^{N - 1} {Px}_{i , k} {x}_{j , l} & ( Equation 11 )\end{matrix}$$

In the production planning setup time optimization problem, there are cases where the setup time does not change even if the order is changed (hereinafter, this will be referred to as the case where the setup time is symmetrical), and cases where the setup time changes if the order is changed (hereinafter, this will be referred to as the case where the setup time is asymmetric).

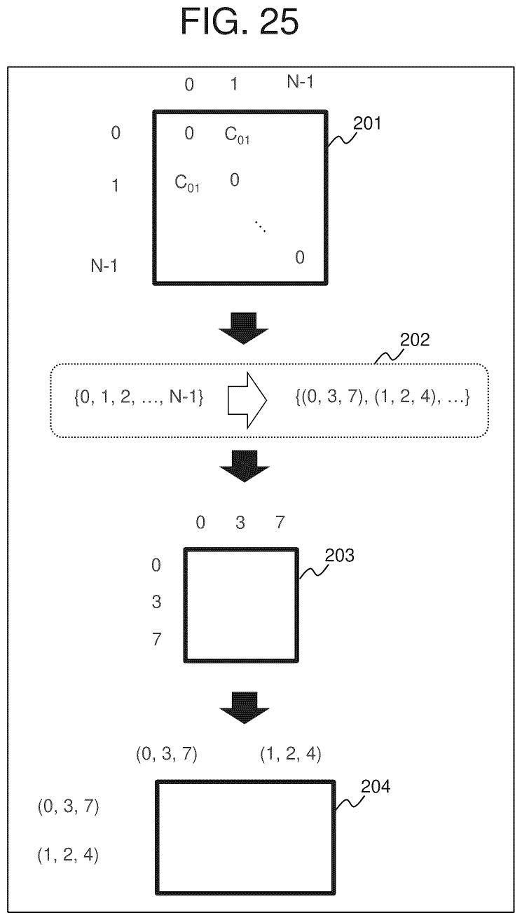

FIG. 25 is an explanatory diagram showing an overview of an algorithm for solving the order optimization problem. In the order optimization problem, the problem dividing unit 51 extracts block 201 from the QUBO matrix. In the case of the production planning setup time optimization problem, the block is a matrix representing the setup time. The problem dividing unit 51 performs clustering 202 of products based on the setup times included in the extracted blocks.

The subproblem optimizing unit 52 optimizes the subproblem indicated by the matrix 203 including the clustered product groups (e.g., {0, 3, 7}, etc.). Here, the subproblem optimizing unit 52 may solve the production planning setup time optimization problem for the clustered range. The problem combining unit 53 formulates a new combinatorial optimization problem (super problem) 204 that combines the optimization results of the obtained subproblems. The super problem optimizing unit 54 then performs the optimization process for the formulated new combinatorial optimization problem (i.e., super problem).

In the example shown in FIG. 25, for example, an optimized order is derived for the {0, 3, 7} products (e.g., the start is “0” and the goal is “7”), so a partially optimized order optimization problem may be optimized. In other words, the subproblem determines the order in the clusters, and then the super problem determines the order among the clusters, so that the combined solution can be regarded as the overall solution.

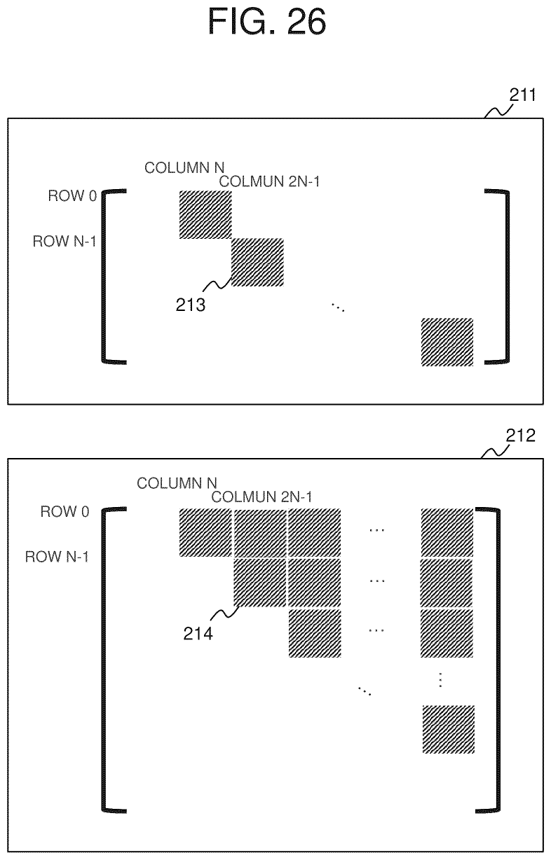

FIG. 26 is an explanatory diagram showing an example of a QUBO matrix showing a setup time optimization problem. In the case of the setup time optimization problem, the QUBO matrix includes components such as TSP and components that represent order constraints in addition to the two-way one-hot condition. Specifically, a block 213 of setup time information for each product appears along the diagonal components of the QUBO matrix 211, and a block 214 of order constraints appears exhaustively in the upper triangle of the QUBO matrix 212. Note that unlike the TSP case, block 213 of information on setup time does not appear in the upper right corner.

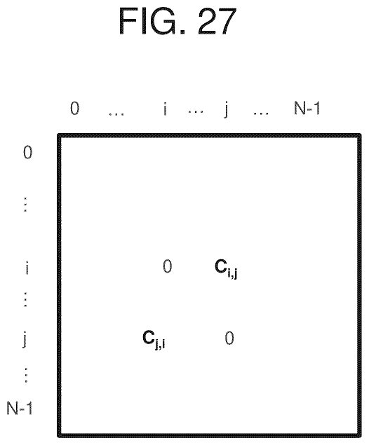

Note that when the setup time is asymmetric, there are some matters to keep in mind when dividing compared to the case when the setup time is symmetric. FIG. 27 is an explanatory diagram showing an example of a matrix (block) showing setup time. For example, when there is an order constraint, it is assumed that a large component is set as a penalty to the setup time corresponding to the prohibited order. For example, if j must not be done before i, then C_{j,i} is the penalty term.

In this case, the problem dividing unit 51 uses the shorter component min (C_{i,j}, C_{j,i}) of the setup time for clustering in the subproblem clustering. The same method of clustering as shown in the TSP above may be used for clustering.

Next, the subproblem optimizing unit 52 optimizes the setup time of n products for the subproblem variables {s₀, s₁, . . . , sₙ₋₁} extracted from the variables {0, 1, 2, . . . , N−1} of the original problem.

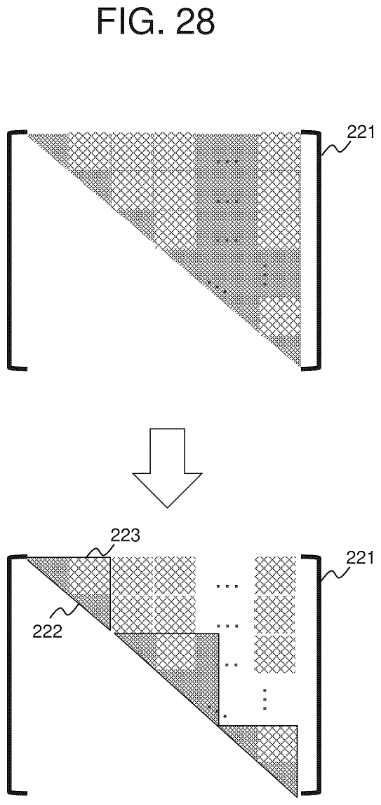

Specifically, the problem dividing unit 51 extracts the necessary components C_{si,sj} from the original setup time matrix as setup time. Furthermore, the problem dividing unit 51 also extracts from the QUBO matrix only the blocks related to the constraints between the products of the subproblems with respect to the constraints on the order of the products. FIG. 28 is an explanatory diagram showing an example of a process of extracting necessary components from a QUBO matrix. The problem dividing unit 51 may extract blocks 223, for example, by extracting the necessary components for each subproblem 222 along the diagonal components from the QUBO matrix 221, which combines the objective function and the order constraints.

The subproblem optimizing unit 52 solves the subproblem setup time optimization problem by adding a two-way one-hot condition to the QUBO matrix of the objective function of the extracted block (subproblem).

The problem combining unit 53 determines the order between subproblems using the first product and the last product in the order derived as the optimal solution to the subproblems. Specifically, the problem combining unit 53 uses the setup time between subproblems as the setup time between the last product of the previous subproblem and the first product of the one after. Similarly for the order constraint, the problem combining unit 53 determines the order between the last product of one previous subproblem and the first product of the one after.

The problem combining unit 53 extracts components from the original QUBO matrix along the diagonal components as in the subproblem formulation. The super problem optimizing unit 54 solves the setup time optimization problem for the super problem by adding a two-way one-hot condition to the QUBO matrix of the objective function of the extracted super problem.

If products for which order constraints are imposed are included in the same subproblem, it is possible to optimize to satisfy the constraints using the QUBO matrix of the subproblem. On the other hand, if products for which order constraints are imposed are included in different subproblems, the constraints may not be satisfied. In this case, the optimizing unit 50 may take the following approach.

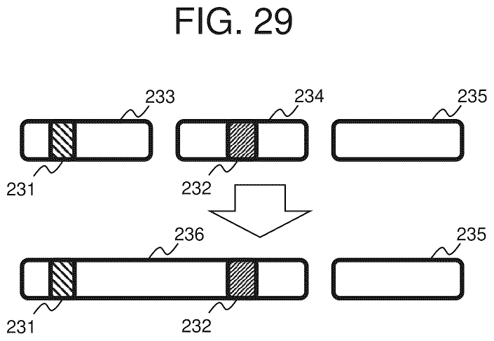

FIG. 29 is an explanatory diagram showing an example of how to formulate a problem. In the example shown in FIG. 29, there is an ordering constraint between elements 231 and 232. Also it is assumed that clusters 233, 234, and 235 are generated as a result of problem division, and element 231 is included in cluster 233 and element 232 is included in cluster 234. Here, in order to satisfy the order constraint between elements 231 and 232, the optimizing unit 50 (e.g., problem dividing unit 51) may combine cluster 233 and cluster 234 to generate cluster 236, which includes both elements 231 and 232. The subproblem optimizing unit 52 may then optimize the problem indicated by the generated cluster 236.

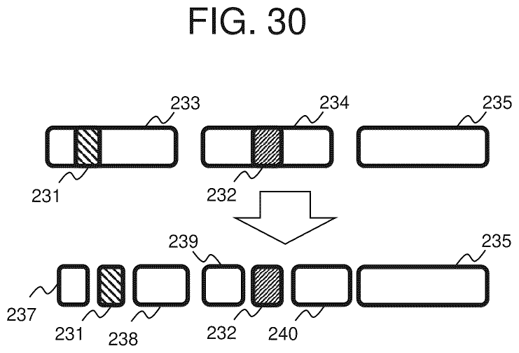

FIG. 30 is an explanatory diagram showing another example of how to formulate a problem. The ordering constraints shown in FIG. 30 are similar to the ordering constraints shown in FIG. 29. In this case, the optimizing unit 50 (e.g., problem dividing unit 51) may divide cluster 233 into cluster 237, element 231 and cluster 238, and cluster 234 into cluster 239, element 232 and cluster 240.

The super problem optimizing unit 54 then optimizes the super problem that combines these clusters based on the results of optimizing each cluster. Specifically, the super problem optimizing unit 54 optimizes the super problems generated according to the order among the determined subproblems.

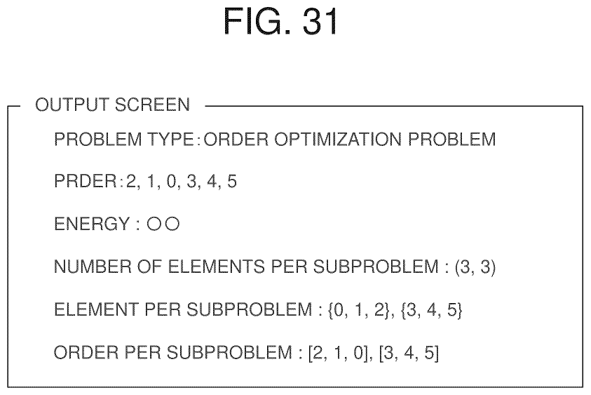

FIG. 31 is an explanatory diagram showing another example of contents output by an output unit 60. The output content shown in FIG. 31 shows the output content of an order optimization problem. The example shown in FIG. 31 also assumes an optimization problem in which six different elements (0-5) are sorted. The example shown in FIG. 31 indicates that the output unit 60 outputs the final order result along with the problem type, the order optimization problem.

The example shown in FIG. 31, similar to what is shown in FIG. 18, also shows that the final order is output together with the energy calculated from the QUBO matrix of the original optimization problem. This energy can also be used as an indicator that a smaller number is considered a better solution.

In addition, FIG. 31 also shows an example of outputting the number of elements per subproblem, elements per subproblem, and order per subproblem for each assigned element.

The input unit 10, the modeling unit 20, the one-hot condition identifying unit 30, the problem determining unit 40, the optimizing unit 50 (more specifically, the problem dividing unit 51, the subproblem optimizing unit 52, the problem combining unit 53, and the super problem optimizing unit 54), and the output unit 60 are realized by a computer processor (e.g., CPU (Central Processing Unit), GPU (Graphics Processing Unit (GPU)) that operates according to a program (parameter generation program).

For example, the program may be stored in the storage unit (not shown) of the optimization device 100, and the processor may read the program and operate as the input unit 10, the modeling unit 20, the one-hot condition identifying unit 30, the problem determining unit 40, the optimizing unit 50 (more specifically, the problem dividing unit 51, the subproblem optimizing unit 52, the problem combining unit 53, and the super problem optimizing unit 54), and the output unit 60 according to the program.

The functions of the input unit 10, the modeling unit 20, the one-hot condition identifying unit 30, the problem determining unit 40, the optimizing unit 50 (more specifically, problem dividing unit 51, the subproblem optimizing unit 52, the problem combining unit 53, and the super problem optimizing unit 54), and the output unit 60 may be provided in a SaaS (Software as a Service) format.

The input unit 10, the modeling unit 20, the one-hot condition identifying unit 30, the problem determining unit 40, the optimizing unit 50 (more specifically, the problem dividing unit 51, the subproblem optimizing unit 52, the problem combining unit 53, and the super problem optimizing unit 54), and the output unit 60 may each be realized by dedicated hardware. Also, some or all of the components of each device may be realized by general-purpose or dedicated circuits (circuitry), processors, etc., or a combination thereof. They may be configured by a single chip or by multiple chips connected via a bus. Part or all of each component of each device may be realized by a combination of the above-mentioned circuits, etc. and a program.

When some or all of the input unit 10, the modeling unit 20, the one-hot condition identifying unit 30, the problem determining unit 40, the optimizing unit 50 (more specifically, problem dividing unit 51, the subproblem optimizing unit 52, the problem combining unit 53, and the super problem optimizing unit 54), and the output unit 60 are realized by multiple information processing devices, circuits, etc., the multiple information processing devices, circuits, etc. may be centrally located or distributed. For example, the information processing devices and circuits may be realized as a client-server system, a cloud computing system, or the like, each of which is connected via a communication network.

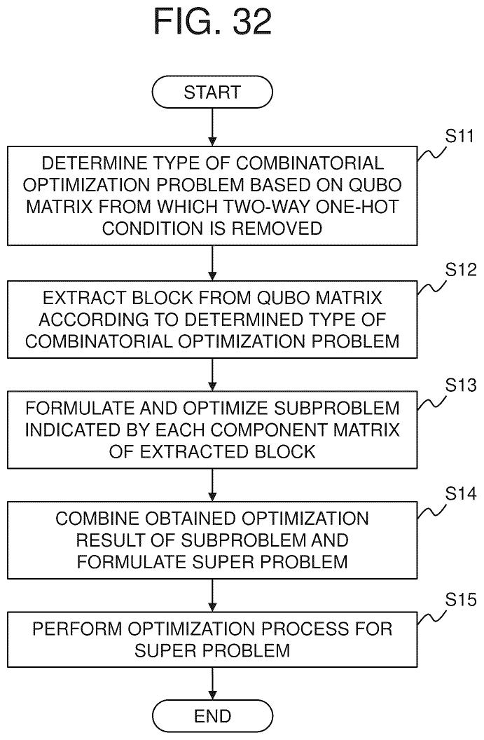

Next, an example of the operation of the optimization device 100 of this example embodiment is described. FIG. 32 is a flowchart showing an example of operation of the optimization device 100 of this example embodiment.

The problem determining unit 40 determines the type of combinatorial optimization problem based on the QUBO matrix from which the two-way one-hot condition is removed (step S11). The problem dividing unit 51 extracts blocks from the QUBO matrix according to the determined type of combinatorial optimization problem (step S12). The subproblem optimizing unit 52 formulates and optimizes the subproblem indicated by each component matrix of the extracted blocks (Step S13). The problem combining unit 53 combines obtained optimization results of the subproblem and formulates a super problem (step S14). The super problem optimizing unit 54 then performs optimization process for the super problem (step S15). The super problem optimizing unit 54 then uses the solutions of the subproblem and the super problem to obtain the original solution.

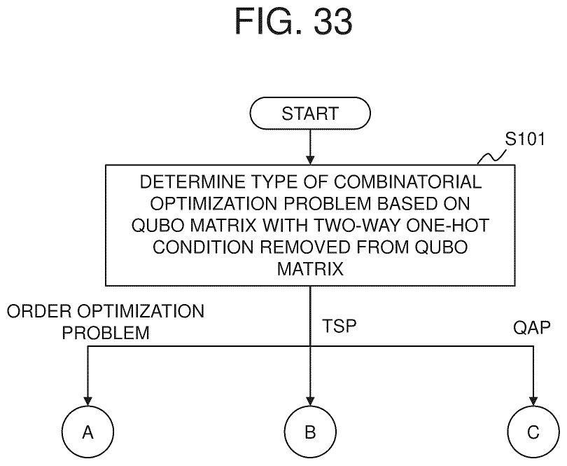

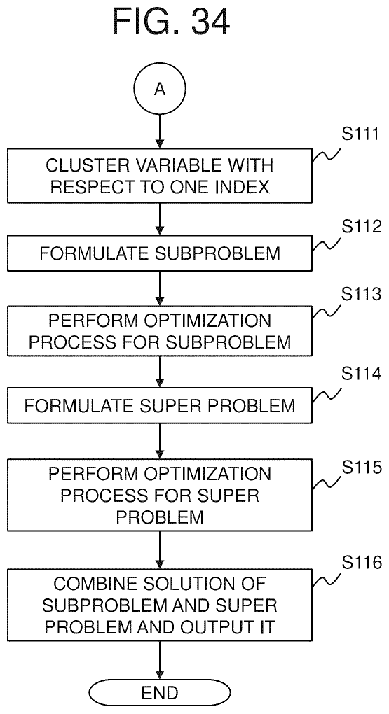

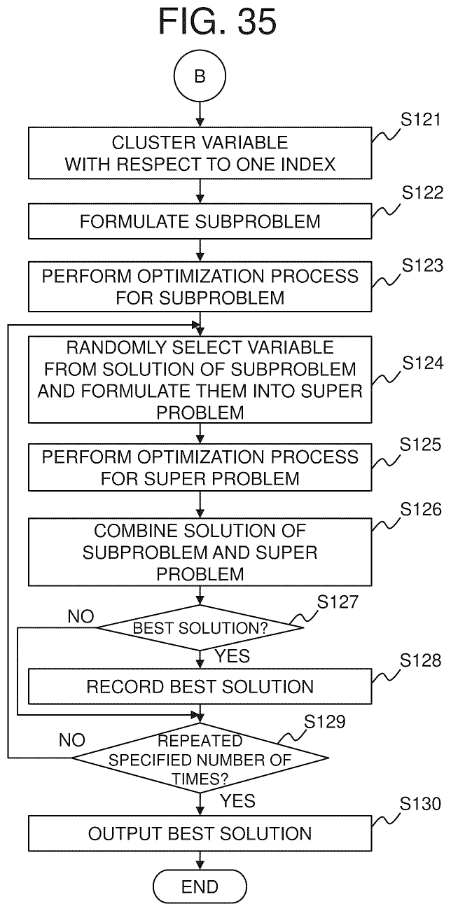

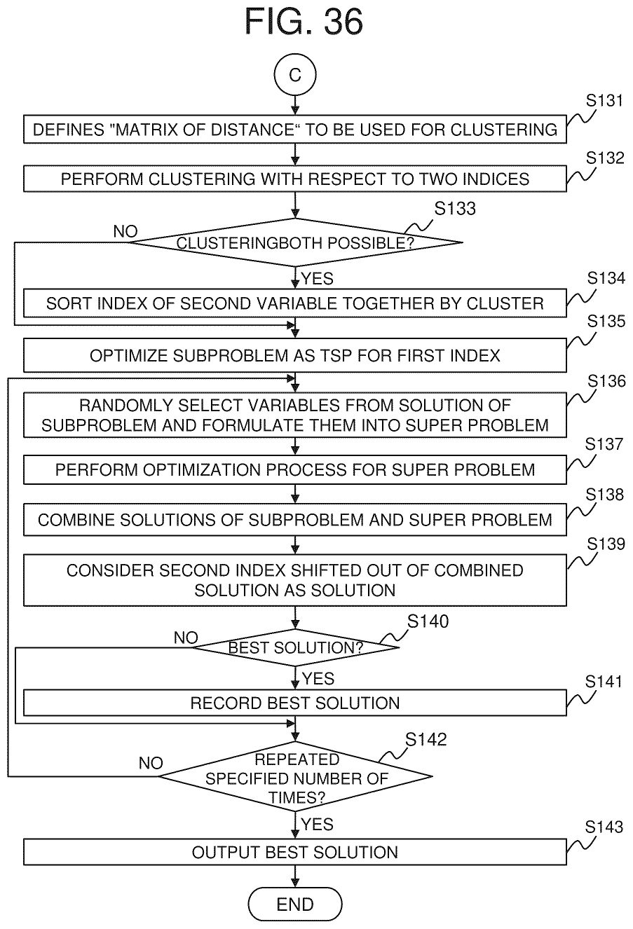

Next, examples of more detailed operations according to the results of determining the type of combinatorial optimization problems is described. FIG. 33-36 are flowcharts showing other examples of operation of the optimization device 100 of this example embodiment. Specifically, FIG. 34 is a flowchart showing another example of operation when the problem is identified as an order optimization problem. FIG. 35 is a flowchart showing another example of operation when the problem is identified as TSP. FIG. 36 is a flowchart showing another example of operation when the problem is identified as QAP.

First, the problem determining unit 40 determines the type of the combinatorial optimization problem (step S101), as shown in the example flowchart in FIG. 32. Here, it is assumed that the problem determining unit 40 determines the type of the combinatorial optimization problem to be an order optimization problem, TSP or QAP.

It is also assumed that the problem determining unit 40 determines that the type of combinatorial optimization problem is an order optimization problem (“order optimization problem” in step S101). In this case, the problem dividing unit 51 performs clustering with respect to one index (step S111 in FIG. 34). Specifically, the problem dividing unit 51 performs clustering of variables with respect to the index representing the items to be ordered.

The subproblem optimizing unit 52 formulates the subproblem (step S112) and performs the optimization process for the subproblem (step S113). Specifically, the subproblem optimizing unit 52 formulates a part of the problem (subproblem) obtained by clustering as the same order optimization problem as the original, and performs optimization process by annealing.

Next, the problem combining unit 53 performs the formulation into a super problem (step S114). Specifically, the problem combining unit 53 extracts only the first and last items of the order obtained as solutions to the subproblems with respect to all subproblems, and formulates the problem of determining the order of clusters using the extracted items (super problem) as an order optimization problem.

The super problem optimizing unit 54 then performs optimization of the super problem by annealing (step S115), combines the solutions of the subproblem and super problem, and the output unit 60 outputs the results (step S116). Specifically, the super problem optimizing unit 54 determines the order among clusters based on the obtained solution of the super problem, and also determines the order within clusters by the solution of the subproblem to create the solution of the original order optimization problem.

Next, it is assumed that the problem determining unit 40 determines that the type of the combinatorial optimization problem is TSP (“TSP” in step S101 in FIG. 33). At this time, the problem dividing unit 51 performs clustering with respect to one index (step S121 in FIG. 35). Specifically, the problem dividing unit 51 performs clustering of variables with respect to the index representing the cities to be arranged.

The subproblem optimizing unit 52 formulates the subproblem (step S122) and performs the optimization process for the subproblem (step S123). Specifically, the subproblem optimizing unit 52 formulates a part of the problem (subproblem) obtained by clustering as the same TSP as the original and performs optimization process by annealing.

Next, the problem combining unit 53 randomly selects variables from the solutions of the subproblems and formulates them into a super problem (step S124). Specifically, the problem combining unit 53 randomly extracts two consecutive cities in the order of cities obtained as solutions to the subproblems for all subproblems, and formulates the problem of determining the order of clusters (super problem) using the extracted cities as the TSP.

The super problem optimizing unit 54 then performs the optimization process for the super problem by annealing (step S125) and combines the solutions of the subproblem and super problem (step S126). Specifically, the super problem optimizing unit 54 creates the original TSP solution by determining the order of the clusters as the solution to the super problem and the order of the cities in the clusters as the solution to the sub problem.

If the optimal solution obtained at this time is the best result among the optimal solutions obtained in the past (sometimes referred to as the best solution) (Yes in step 127), then the super problem optimizing unit 54 records the best solution (step S128).

The super problem optimizing unit 54 then determines whether it has been repeated the specified number of times (Step S129). If it has been repeated the specified number of times (Yes in step S129), the output unit 60 outputs the best solution (step S130). On the other hand, if it has not been repeated the specified number of times (No in step S129), step S124 and subsequent processes are repeated.

Next, it is assumed that the problem determining unit 40 determines that the type of the combinatorial optimization problem is QAP (“QAP” in step S101 in FIG. 33). In this case, the problem dividing unit 51 defines a matrix of distances to be used for clustering (step S131 in FIG. 36). The problem dividing unit 51 also performs clustering with respect to the two indices (step S132). Specifically, to cluster the variables as in TSP using the QUBO matrix, the problem dividing unit 51 defines the quantity that corresponds to the distance in TSP from the QUBO matrix and tries to cluster the variables with respect to both indices of the variables represented by a two-dimensional array.

If clustering is possible for both indices (Yes in step S133), the subproblem optimizing unit 52 sorts the indices of the second variable together by cluster (step S134) and proceeds to step S135. Specifically, the subproblem optimizing unit 52 determines whether clustering is possible with respect to both indices, and if clustering is possible for both indices, the indices of the clustered second variable are sorted together by cluster.

If clustering of both indices is possible and after step S134 is performed, or if clustering of both indices is not possible (No in step S133), the subproblem optimizing unit 52 optimizes the subproblem as TSP for the first index (step S135). Specifically, the subproblem optimizing unit 52 clusters the indices of variables that are not clustered at this point by the matrix defined in step S132 (matrix of distances) and optimizes the subproblem from this matrix as TSP, not QAP.

Next, the problem combining unit 53 randomly selects variables from the solutions of the subproblems and formulates them into a super problem (step S136). Specifically, the problem combining unit 53 uses the order of subproblem solutions obtained in step S135 and randomly extracts two consecutive items in the order of items obtained as solutions to the subproblems for all subproblems, in the same manner as when solving the TSP. Then, the problem combining unit 53 formulates the problem of determining the order of clusters (super problem) using the extracted items as the TSP.

Then, the super problem optimizing unit 54 performs the optimization process for the super problem by annealing (step S137) and combines the solutions of the subproblem and super problem (step S138). Specifically, the super problem optimizing unit 54 creates an order of solutions to the original problem by determining the order of solutions between clusters as the solution to the super problem and also by determining the order of items in the clusters from the solution to the subproblem.

In addition, the super problem optimizing unit 54 also considers the second index shifted out of the combined solution as a solution (step S139). Specifically, the super problem optimizing unit 54 shifts the order of solutions obtained with respect to the other index to search for a better solution.

If the optimal solution obtained at this time is the best result (i.e., the best solution) among the optimal solutions obtained in the past (Yes in step 140), the super problem optimizing unit 54 records that best solution (step S141). This is because the two items to be extracted from the subproblem solution are chosen randomly, and the solution obtained is assumed to be different each time.

The super problem optimizing unit 54 then determines whether it has been repeated the specified number of times (Step S142). If it has been repeated the specified number of times (Yes in step S142), the output unit 60 outputs the best solution (step S143). On the other hand, if it has not been repeated the specified number of times (No in step S142), step S136 and subsequent processes are repeated.

As described above, in this example embodiment, the problem determining unit 40 determines the type of the combinatorial optimization problem from the QUBO matrix obtained by QUBO modeling of a combinatorial optimization problem that includes a two-way one-hot condition as a constraint condition, and the optimizing unit 50 performs optimization process according to the determined type of the combinatorial optimization problem. Thus, an appropriate optimization process can be performed according to the QUBO-modeled optimization problem.

For example, an engineer who is familiar with the use of equipment such as simulated annealing or quantum annealing is likely to be able to perform problem division appropriately. However, those who have difficulty performing proper problem division may let the device solve the original scale (i.e., large scale) problem as it is, without performing problem division. In this case, it is difficult to perform an appropriate optimization process.

The large number of variables also makes the problem more difficult to solve in terms of adhering to the constraints. A combinatorial optimization problem with constraints is more difficult than a combinatorial optimization problem without constraints in the sense that the obtained solution cannot be interpreted as a meaningful solution unless all the given constraints are satisfied. The constraint conditions here are the conditions that must be satisfied by the solution after an annealing calculation by simulated annealing or quantum annealing, such as the one-hot condition.

Furthermore, in the formulation of the Hamiltonian used in annealing calculations, if the coefficient parameters are not set appropriately, a solution that satisfies the constraints but is far from the optimal solution is obtained.

To explain in more detail, specialized engineers think, “Many real-world problems are so large that it is not realistic to solve them as they are,” and they consider whether the problem can be divided and how to combine the solutions of the divided problems so that they become the solutions of the original problem. On the other hand, the average user thinks, “If I can formulate the problem, then the Ising machine can do the rest of the calculations,” and so they model the entire optimization problem as a QUBO model and have the Ising machine perform the calculations. However, in this case, there are inherent difficulties, such as the need to adjust the coefficient parameters to satisfy the constraint conditions, and the problem that even if the constraint conditions are satisfied, the solution is not necessarily close to the optimal solution.

On the other hand, in this example embodiment, the optimizing unit 50 performs problem division according to the type of the determined combinatorial optimization problem. Therefore, it becomes possible to perform more appropriate optimization process.

### Example Embodiment 2

Next, a second example embodiment of the optimization system is described. The first example embodiment describes a method of dividing and optimizing the QUBO matrix based on the determined type of the combinatorial optimization problem. The second example embodiment describes a method of converting the QUBO matrix based on the determined type of combinatorial optimization problem and optimizing it according to a dedicated algorithm.

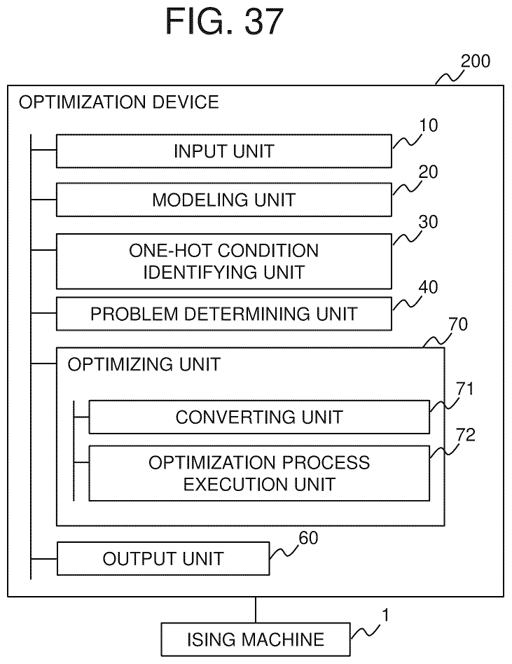

FIG. 37 is an explanatory diagram showing a configuration example of a second example embodiment of the optimization device according to the present invention. The optimization device 200 of the second embodiment includes the input unit 10, the modeling unit 20, the one-hot condition identifying unit 30, the problem determining unit 40, an optimizing unit 70, and the output unit 60. The optimizing unit 70 includes a converting unit 71 and an optimization process execution unit 72.

In other words, the optimization device 200 of this example embodiment differs from the configuration of the first example embodiment in that it has the optimizing unit 70 instead of the optimizing unit 50. Other configurations are similar to those of the first example embodiment.

The converting unit 71 converts the QUBO matrix based on the determined type of the combinatorial optimization problem. Specifically, the format to be converted is predetermined according to the type of the determined combinatorial optimization problem, and the converting unit 71 converts the QUBO matrix to the format determined according to the determined type. This format is determined according to the manner in which the optimization process execution unit 72, described below, can execute the optimization process.

For example, if the combinatorial optimization problem is TSP, the converting unit 71 may, for example, convert the QUBO matrix so that an existing TSP solver can execute it. The method of converting the QUBO matrix is arbitrary, and any known method may be used.

The optimization process execution unit 72 executes the optimization process for the original combinatorial optimization problem in the converted format. The optimization process execution unit 72 may, for example, execute the optimization process with an optimization solver for the combinatorial optimization problem. The optimization process execution unit 72 may, for example, give execution instructions to other devices (not shown) that execute the optimization process, or the optimization process may be executed by the optimization device 200 itself.

The input unit 10, the modeling unit 20, the one-hot condition identifying unit 30, the problem determining unit 40, the optimizing unit 70 (more specifically, the converting unit 71 and the optimization process execution unit 72), and the output unit 60 are realized by a computer processor operating according to a program (optimization program).

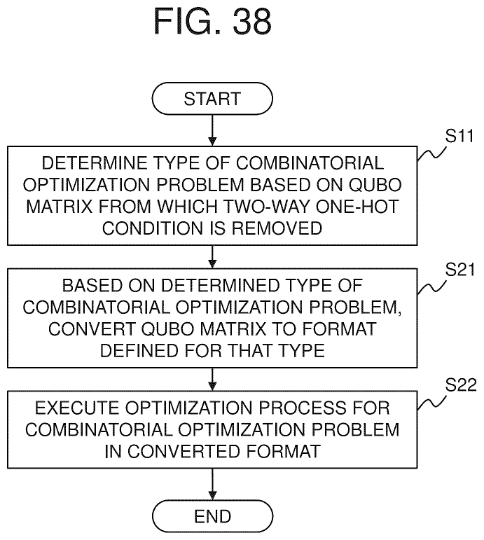

Next, an example of the operation of the optimization device 200 of this example embodiment is described. FIG. 38 is a flowchart showing an example of operation of the optimization device 200 of this example embodiment. The process of determining the type of combinatorial optimization problem is the same as the process of step S11 shown in FIG. 32.

The converting unit 71 converts the QUBO matrix to a format defined for the type of combinatorial optimization problem based on the determined type of combinatorial optimization problem (step S21). Then, the optimization process execution unit 72 executes the optimization process for the combinatorial optimization problem in the converted format (step S22).

As described above, in this example embodiment, the converting unit 71 converts the QUBO matrix based on the determined type of the combinatorial optimization problem to a format defined for that type, and the optimization process execution unit 72 executes the optimization process for the combinatorial optimization problem in the converted format. Therefore, as in the first example embodiment, an appropriate optimization process can be performed according to the QUBO-modeled optimization problem.

### Example Embodiment 3

Next, a third example embodiment of the optimization device is described. In the second example embodiment, In the second example embodiment, a method of converting a QUBO matrix according to an algorithm for performing optimization processing is described. In the third embodiment, a method of searching for a better solution based on the results output by the Ising machine is described. In this example embodiment, a case is described in which the optimization process for the QUBO-modeled combinatorial optimization problem is directly performed using an Ising machine such as an annealing machine. Note that the process performed by the optimization device of this example embodiment may be performed on the results output by the optimization device 100 of the first example embodiment and the optimization device 200 of the second example embodiment.

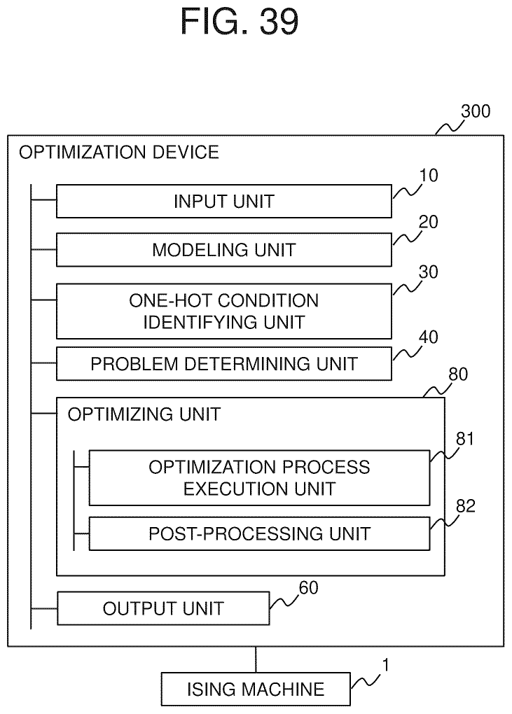

FIG. 39 is an explanatory diagram showing a configuration example of a third example embodiment of the optimization device according to the present invention. The optimization device 300 of the third example embodiment includes the input unit 10, the modeling unit 20, the one-hot condition identifying unit 30, the problem determining unit 40, an optimizing unit 80, and the output unit 60. The optimizing unit 80 includes an optimization process execution unit 81 and a post-processing unit 82.

In other words, the optimization device 300 of this example embodiment differs from the configuration of the first example embodiment in that it has the optimizing unit 80 instead of the optimizing unit 50. The rest of the configuration is the same as in the first example embodiment.

The optimization process execution unit 81 executes the QUBO-modeled optimization problem. Specifically, the optimization process execution unit 81 performs optimization process by causing an Ising machine to execute an optimization problem modeled as a QUBO model. In this example embodiment, the optimization process execution unit 81 causes the QUBO-modeled optimization problem itself to be executed by the Ising machine 1.

The post-processing unit 82 post-processes solution obtained as a result of the optimization process according to the type of combinatorial optimization problem. The post-processing performed by the post-processing unit 82 is arbitrary. For example, the post-processing unit 82 may, for example, modify the optimal solution to satisfy the constraint conditions or further search for a more appropriate solution.

Since the order optimization problem, TSP, and QAP described above can all be said to be assignment-determining problems, the post-processing unit 82 may, for example, perform the operation of exchanging assignments as post-processing. In this case, the post-processing unit 82 may post-process using a local search algorithm (an algorithm that searches for a better solution by exchanging two elements). The post-processing that can be performed in the case of TSP includes, for example, the 2-opt method.

In addition, the solution by the annealing machine may not satisfy the one-hot condition, even though the problem that must satisfy the one-hot condition is being solved. Therefore, the post-processing unit 82 may post-process to adjust the zeros and ones as appropriate so that the obtained solution satisfies the one-hot condition, using, for example, the method described in Non Patent Literature 1.

The input unit 10, the modeling unit 20, the one-hot condition identifying unit 30, the problem determining unit 40, the optimizing unit 80 (more specifically, the optimization process execution unit 81 and the post-processing unit 82), and the output unit 60 are realized by a computer processor operating according to a program (optimization program).

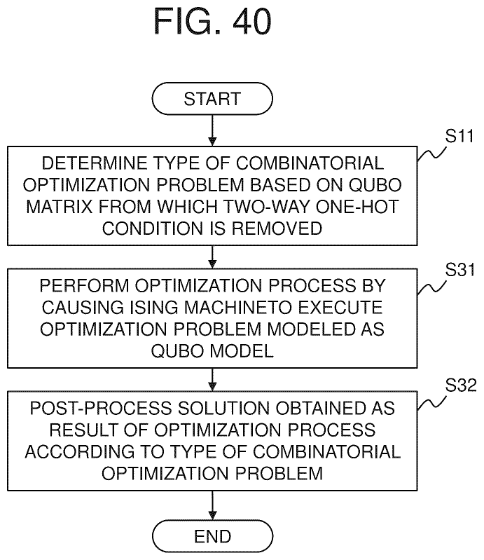

Next, an example of the operation of the optimization device 300 of this example embodiment is described. FIG. 40 is a flowchart showing an example of operation of the optimization device 300 of this example embodiment. The process of determining the type of combinatorial optimization problem is the same as the process of step S11 shown in FIG. 32.

The optimization process execution unit 81 performs the optimization process by causing the Ising machine to execute an optimization problem modeled as a QUBO model (step S31). The post-processing unit 82 then post-processes solution obtained as a result of the optimization process according to the type of combinatorial optimization problem. (step S32).

As described above, in this example embodiment, the optimization process execution unit 81 performs optimization process by causing the Ising machine system to execute an optimization problem modeled as a QUBO model, and the post-processing unit 82 post-processes the solution obtained as a result of the optimization process according to the type of combinatorial optimization problem. Therefore, as in the first example embodiment, an appropriate optimization process can be performed according to the QUBO-modeled optimization problem.

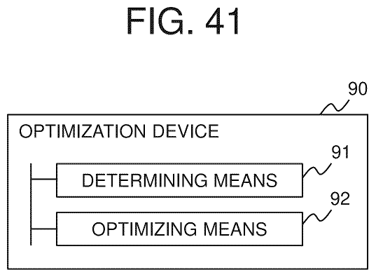

The following is an overview of the invention. FIG. 41 is a block diagram showing an overview of the optimization device according to the present invention. The optimization device 90 (e.g., the optimization device 100, 200, 300) according to the present invention includes a determining means 91 (e.g., the problem determining unit 40) which determines a type of combinatorial optimization problem from a QUBO matrix obtained by QUBO modeling of a combinatorial optimization problem that includes a two-way one-hot condition as a constraint condition, and an optimizing means 92 (e.g., the optimizing unit 50, 70, 80) which performs optimization process according to the determined type of combinatorial optimization problem.

Such a configuration allows the appropriate optimization process to be performed according to the QUBO-modeled optimization problem.

The determining means 91 may determine the type of combinatorial optimization problem by comparing distribution of non-zero components of an objective function part, which is a matrix from which the two-way one-hot condition is removed from the QUBO matrix, with distribution of components determined according to a type of combinatorial optimization problem.

The optimizing means 92 may include a problem dividing means (e.g., the problem dividing unit 51) which extracts a block, from the QUBO matrix, that is a square matrix including non-zero components according to the determined type of combinatorial optimization problem, a subproblem optimizing means (e.g., the subproblem optimizing unit 52) which optimizes a subproblem, which is a problem indicated by each component matrix of the extracted block, by a method determined according to an original combinatorial optimization problem, a problem combining means (e.g., the problem combining unit 53) which combines obtained optimization results of the subproblem and formulates a new combinatorial optimization problem as a super problem, and a super problem optimizing means (e.g., the super problem optimizing unit 54) which performs optimization process for the super problem.

In this case, the problem dividing means may generate a block with the indices sorted so that values of the components in a first row of the extracted block are in ascending order, and if the ratio or difference of adjacent components exceeds a predetermined threshold (e.g., threshold t_{cl}), generate a new block by dividing a square matrix including rows up to adjacent left component.

Otherwise, the problem dividing means may define an average of sum of components in the QUBO matrix of a cluster, which is a set of indices of variables, as distance between the clusters (e.g., Equation 8 shown above), and divide the block by performing process of combining clusters that are close in the distance to each other and repeating the process of combining clusters until the predefined conditions are met.

The problem combining means may formulate the problem according to a method determined according to the original combinatorial optimization problem.

On the other hand, the optimizing means may include a converting means (e.g., the converting unit 71) which converts the QUBO matrix, based on the determined type of combinatorial optimization problem, into a format determined according to the determined type, and a first optimization process execution means (e.g., the optimization process execution unit 72) which executes optimization process for the combinatorial optimization problem in the converted format.

The optimizing means may also, as another form of optimization, include a second optimization process execution means (e.g., the optimization process execution unit 81) which performs optimization process by causing an Ising machine to execute an optimization problem modeled as a QUBO model, and a post-processing means (e.g. the post-processing unit 82) which post-processes solution obtained as a result of the optimization process according to the type of combinatorial optimization problem.

Although some or all of the above example embodiments may also be described as in the following Supplementary notes, but not limited to the following.

(Supplementary note 1) An optimization device comprising:
a determining means which determines a type of combinatorial optimization problem from a QUBO matrix obtained by QUBO modeling of a combinatorial optimization problem that includes a two-way one-hot condition as a constraint condition; and
an optimizing means which performs optimization process according to the determined type of combinatorial optimization problem.

(Supplementary note 2) The optimization device according to Supplementary note 1, wherein
the determining means determines the type of combinatorial optimization problem by comparing distribution of non-zero components of an objective function part, which is a matrix from which the two-way one-hot condition is removed from the QUBO matrix, with distribution of components determined according to a type of combinatorial optimization problem.

(Supplementary note 3) The optimization device according to Supplementary note 1 or 2, wherein the optimizing means includes:
a problem dividing means which extracts a block, from the QUBO matrix, that is a square matrix including non-zero components according to the determined type of combinatorial optimization problem;
a subproblem optimizing means which optimizes a subproblem, which is a problem indicated by each component matrix of the extracted block, by a method determined according to an original combinatorial optimization problem;
a problem combining means which combines obtained optimization results of the subproblem and formulates a new combinatorial optimization problem as a super problem; and
a super problem optimizing means which performs optimization process for the super problem.

(Supplementary note 4) The optimization device according to Supplementary note 3, wherein
the problem dividing means generates a block with the indices sorted so that values of the components in a first row of the extracted block are in ascending order, and if the ratio or difference of adjacent components exceeds a predetermined threshold, generates a new block by dividing a square matrix including rows up to adjacent left component.

(Supplementary note 5) The optimization device according to Supplementary note 3, wherein
the problem dividing means defines an average of sum of components in the QUBO matrix of a cluster, which is a set of indices of variables, as distance between the clusters, and divides the block by performing process of combining clusters that are close in the distance to each other and repeating the process of combining clusters until the predefined conditions are met.

(Supplementary note 6) The optimization device according to any one of Supplementary notes 3 to 5, wherein
the problem combining means formulates the problem according to a method determined according to the original combinatorial optimization problem.

(Supplementary note 7) The optimization device according to any one of Supplementary notes 3 to 6, wherein
the problem combining means selects, for each region, two cities that are contiguous in order out of the order of each region optimized in the subproblem, and formulates a traveling salesman problem visiting the two cities selected for each region as a new combinatorial optimization problem, and
the super problem optimizing means inserts the optimization result optimized for each region into the optimization results of the optimized combinatorial optimization problem.

(Supplementary note 8) The optimization device according to Supplementary note 7, wherein
the problem dividing means identifies a block to be used as criteria for clustering, and tries whether clustering is possible or not for the vertical and horizontal directions of the identified block, and
the super problem optimizing means repeats the optimization process while changing a value of an index of the other clustering by 1 according to results of a clustering trial in either the vertical or horizontal direction.

(Supplementary note 9) The optimization device according to any one of Supplementary notes 3 to 6, wherein
the problem dividing means extracts a block related to constraints between products of the subproblem from the QUBO matrix regarding constraints on product order,
the subproblem optimizing means optimizes the subproblem by adding the two-way one-hot condition to the QUBO matrix of an objective function of the extracted block,
a problem combining means uses a first product and a last product in order derived as the optimal solution of the subproblem to formulate a problem for determining an order of the subproblems, and
the super problem optimizing means optimizes the super problem to determine the order among the generated subproblems.

(Supplementary note 10) The optimization device according to Supplementary note 1 or 2, wherein the optimizing means includes:
a converting means which converts the QUBO matrix, based on the determined type of combinatorial optimization problem, into a format determined according to the determined type; and
a first optimization process execution means which executes optimization process for the combinatorial optimization problem in the converted format.

(Supplementary note 11) The optimization device according to Supplementary note 1 or 2, wherein the optimizing means includes:
a second optimization process execution means which performs optimization process by causing an Ising machine to execute an optimization problem modeled as a QUBO model; and
a post-processing means which post-processes solution obtained as a result of the optimization process according to the type of combinatorial optimization problem.

(Supplementary note 12) An optimization device comprising:
a problem dividing means which extracts from a QUBO matrix obtained by QUBO modeling of a combinatorial optimization problem that includes a two-way one-hot condition as a constraint condition, a block that is a square matrix including non-zero components according to a type of the combinatorial optimization problem;
a subproblem optimizing means which optimizes a subproblem, which is a problem indicated by each component matrix of the extracted block, by a method determined according to an original combinatorial optimization problem;
a problem combining means which combines obtained optimization results of the subproblem and formulates a new combinatorial optimization problem as a super problem; and
a super problem optimizing means which performs optimization process for the super problem,
wherein the problem dividing means generates a block with the indices sorted so that values of the components in a first row of the extracted block are in ascending order, and if the ratio or difference of adjacent components exceeds a predetermined threshold, generates a new block by dividing a square matrix including rows up to adjacent left component.

(Supplementary note 13) An optimization device comprising:
a problem dividing means which extracts from a QUBO matrix obtained by QUBO modeling of a combinatorial optimization problem that includes a two-way one-hot condition as a constraint condition, a block that is a square matrix including non-zero components according to a type of the combinatorial optimization problem;
a subproblem optimizing means which optimizes a subproblem, which is a problem indicated by each component matrix of the extracted block, by a method determined according to an original combinatorial optimization problem;
a problem combining means which combines obtained optimization results of the subproblem and formulates a new combinatorial optimization problem as a super problem; and
a super problem optimizing means which performs optimization process for the super problem,
wherein the problem dividing means defines an average of sum of components in the QUBO matrix of a cluster, which is a set of indices of variables, as distance between the clusters, and divides the block by performing process of combining clusters that are close in the distance to each other and repeating the process of combining clusters until the predefined conditions are met.

(Supplementary note 14) An optimization method comprising:
determining a type of combinatorial optimization problem from a QUBO matrix obtained by QUBO modeling of a combinatorial optimization problem that includes a two-way one-hot condition as a constraint condition, by a computer; and
performing optimization process according to the determined type of combinatorial optimization problem, by the computer.

(Supplementary note 15) An optimization program for causing a computer to execute:
determining process for determining a type of combinatorial optimization problem from a QUBO matrix obtained by QUBO modeling of a combinatorial optimization problem that includes a two-way one-hot condition as a constraint condition; and
optimizing process for performing optimization process according to the determined type of combinatorial optimization problem.

The above description of the present invention is with reference to the embodiments and examples, but the present invention is not limited to the above embodiments and examples. Various changes can be made in the composition and details of the present invention that can be understood by those skilled in the art within the scope of the present invention.

This application claims priority based on Japanese patent application 2021-194081, filed on Nov. 30, 2021, the entire disclosure of which is hereby incorporated.

### REFERENCE SIGNS LIST

1 Ising machine
10 Input unit
20 Modeling unit
30 One-hot condition identifying unit
40 Problem determining unit
50, 70, 80 Optimizing unit
51 Problem dividing unit
52 Subproblem optimizing unit
53 Problem combining unit
54 Super problem optimizing unit
60 Output unit
71 Converting unit
72 Optimization process execution unit
81 Optimization process execution unit
82 Post-processing unit

What is claimed is:

1. An optimization device comprising:
a memory storing instructions; and
one or more processors configured to execute the instructions to:
determine a type of combinatorial optimization problem from a QUBO matrix obtained by QUBO modeling of a combinatorial optimization problem that includes a two-way one-hot condition as a constraint condition; and
perform optimization process according to the determined type of combinatorial optimization problem.

2. The optimization device according to claim 1, wherein the processor is configured to execute the instructions to
determine the type of combinatorial optimization problem by comparing distribution of non-zero components of an objective function part, which is a matrix from which the two-way one-hot condition is removed from the QUBO matrix, with distribution of components determined according to a type of combinatorial optimization problem.

3. The optimization device according to claim 1, wherein the processor is configured to execute the instructions to:
extract a block, from the QUBO matrix, that is a square matrix including non-zero components according to the determined type of combinatorial optimization problem;
optimize a subproblem, which is a problem indicated by each component matrix of the extracted block, by a method determined according to an original combinatorial optimization problem;
combine obtained optimization results of the subproblem and formulate a new combinatorial optimization problem as a super problem; and
perform optimization process for the super problem.

4. The optimization device according to claim 3, wherein the processor is configured to execute the instructions to
generate a block with the indices sorted so that values of the components in a first row of the extracted block are in ascending order, and if the ratio or difference of adjacent components exceeds a predetermined threshold, generate a new block by dividing a square matrix including rows up to adjacent left component.

5. The optimization device according to claim 3, wherein the processor is configured to execute the instructions to
define an average of sum of components in the QUBO matrix of a cluster, which is a set of indices of variables, as distance between the clusters, and divide the block by performing process of combining clusters that are close in the distance to each other and repeating the process of combining clusters until the predefined conditions are met.

6. The optimization device according to claim 3, wherein the processor is configured to execute the instructions to
formulate the super problem according to a method determined according to the original combinatorial optimization problem.

7. The optimization device according to claim 3, wherein the processor is configured to execute the instructions to:
select, for each region, two cities that are contiguous in order out of the order of each region optimized in the subproblem, and formulate a traveling salesman problem visiting the two cities selected for each region as a new combinatorial optimization problem; and
insert the optimization result optimized for each region into the optimization results of the optimized combinatorial optimization problem.

8. The optimization device according to claim 7, wherein the processor is configured to execute the instructions to:
identify a block to be used as criteria for clustering, and try whether clustering is possible or not for the vertical and horizontal directions of the identified block; and
repeat the optimization process while changing a value of an index of the other clustering by 1 according to results of a clustering trial in either the vertical or horizontal direction.

9. The optimization device according to claim 3, wherein the processor is configured to execute the instructions to:
extract a block related to constraints between products of the subproblem from the QUBO matrix regarding constraints on product order;
the subproblem optimizing means optimizes the subproblem by adding the two-way one-hot condition to the QUBO matrix of an objective function of the extracted block;
a problem combining means uses a first product and a last product in order derived as the optimal solution of the subproblem to formulate a super problem for determining an order of the subproblems; and
the super problem optimizing means optimizes the super problem to determine the order among the generated subproblems.

10. The optimization device according to claim 1, wherein the processor is configured to execute the instructions to:
convert the QUBO matrix, based on the determined type of combinatorial optimization problem, into a format determined according to the determined type; and
execute optimization process for the combinatorial optimization problem in the converted format.

11. The optimization device according to claim 1, wherein the processor is configured to execute the instructions to:
perform optimization process by causing an Ising machine to execute an optimization problem modeled as a QUBO model; and
post-process solution obtained as a result of the optimization process according to the type of combinatorial optimization problem.

12. An optimization device comprising:
a memory storing instructions; and
one or more processors configured to execute the instructions to:
extract from a QUBO matrix obtained by QUBO modeling of a combinatorial optimization problem that includes a two-way one-hot condition as a constraint condition, a block that is a square matrix including non-zero components according to a type of the combinatorial optimization problem;
optimize a subproblem, which is a problem indicated by each component matrix of the extracted block, by a method determined according to an original combinatorial optimization problem;
combine obtained optimization results of the subproblem and formulate a new combinatorial optimization problem as a super problem;
perform optimization process for the super problem; and
generate a block with the indices sorted so that values of the components in a first row of the extracted block are in ascending order, and if the ratio or difference of adjacent components exceeds a predetermined threshold, generate a new block by dividing a square matrix including rows up to adjacent left component.

13. An optimization device comprising:
a memory storing instructions; and
one or more processors configured to execute the instructions to:
extract from a QUBO matrix obtained by QUBO modeling of a combinatorial optimization problem that includes a two-way one-hot condition as a constraint condition, a block that is a square matrix including non-zero components according to a type of the combinatorial optimization problem;
optimize a subproblem, which is a problem indicated by each component matrix of the extracted block, by a method determined according to an original combinatorial optimization problem;
combine obtained optimization results of the subproblem and formulate a new combinatorial optimization problem as a super problem;
perform optimization process for the super problem; and
define an average of sum of components in the QUBO matrix of a cluster, which is a set of indices of variables, as distance between the clusters, and divide the block by performing process of combining clusters that are close in the distance to each other and repeating the process of combining clusters until the predefined conditions are met.

14-15. (canceled)
